(19) United States
(12) Patent Application Publication
(10) Pub. No.: US 2007/0269665 A1
(43) Pub. Date: Nov. 22, 2007

(54) Polyimide Resin Composition, Polymer Film Containing Polymide Resin and Laminate Using the Same, and Method for Manufacturing Printed Wiring Board

(75) Inventors: Kanji Shimoohsako, Osaka (JP); Shigeru Tanaka, Osaka (JP); Masaru Nishiaka, Shiga (JP); Takashi Itoh, Shiga (JP); Mutsuaki Murakami, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, OSAKA-SHI (JP)

(21) Appl. No.: 10/557,307

(22) PCT Filed: May 17, 2004
(86) PCT No.: PCT/JP04/07007

§ 371 Date: Mar. 12, 2007

(30) Foreign Application Priority Data
May 20, 2003 (JP) 2003-142686
May 20, 2003 (JP) 2003-141622
Oct. 28, 2003 (JP) 2003-367516

(51) Int. Cl. B32B 15/08; C23C 28/00; C08L 81/00

(52) U.S. Cl. 428/458; 205/188; 525/535

(57) ABSTRACT

The present invention relates to a polyimide resin composition including an organic thiol compound and a thermoplastic polyimide resin, a polymeric film containing the polyimide resin, a laminate including the same, and a printed circuit board. By using the polyimide resin composition, it is possible to form an electroless plating film having high adhesive strength even under high-temperature, high-humidity conditions in spite of the fact that the surface roughness of the insulating layer is extremely low. Furthermore, by using the polymeric film and a laminate including the polymeric film and a metal layer, it is possible to obtain a printed circuit board capable of forming high-density circuit and having excellent adhesiveness, and excellent adhesion reliability in a high-temperature, high-humidity environment.

### TECHNICAL FIELD

The present invention relates to a polyimide resin composition used for printed circuit boards which are widely used for electrical and electronic devices.

Furthermore, the present invention relates to a polymeric film containing a polyimide resin, a laminate including the polymeric film, and a printed wiring board (hereinafter referred to as “a printed circuit board”). More particularly, for example, the invention relates to a single layer film formed using a polyimide resin composition, a polymeric film having a two-layer structure including “a thermoplastic polyimide resin layer/a non-thermoplastic polyimide resin layer”, a polymeric film having a three-layer structure including “a thermoplastic polyimide resin layer/a non-thermoplastic polyimide resin layer/a thermoplastic polyimide resin”, and a laminate having a three-layer structure including “a thermoplastic polyimide resin layer/a non-thermoplastic polyimide resin layer/a metal foil layer” or “a thermoplastic polyimide resin layer/a non-thermoplastic polyimide resin layer/an adhesive layer”, which are suitable for use in manufacturing printed circuit boards, and the invention also relates to a printed circuit board including any of these polymeric films or laminates.

Furthermore, the present invention relates to a laminate including a polymeric film containing a polyimide resin and a metal layer, which is suitable for use in manufacturing printed circuit boards, and a printed circuit board including the laminate.

By manufacturing printed circuit boards using these polymeric films and laminates, it is possible to provide high-density flexible printed circuit boards exhibiting excellent adhesiveness, multilayer flexible printed circuit boards in which flexible printed circuit boards are laminated, rigid-flex circuit boards in which flexible printed circuit boards and rigid printed circuit boards are laminated, build-up circuit boards, tapes for tape automated bonding (TAB), chip-on-film (COF) substrates in which semiconductor devices are directly mounted on printed circuit boards, multi-chip module (MCM) substrates, and the like.

Furthermore, the present invention relates to a method for manufacturing a printed circuit board, which is characterized in that when a wiring is formed on a surface of an insulating layer despite the fact that the insulating layer has extremely small surface roughness, satisfactory adhesion strength is obtained between the insulating layer and an electroless plating layer constituting the wiring not only in the normal state but also under high-temperature, high-humidity conditions. More particularly, the invention relates to a method for manufacturing a printed circuit board which is applicable to a build-up circuit board having excellent adhesiveness with a conductive layer composed of a metal and excellent environmental stability, a COF substrate in which semiconductor devices are directly mounted on a printed circuit board, a MCM substrate, and the like.

### BACKGROUND ART

Printed circuit boards are widely used for mounting electronic parts, semiconductor devices, etc., and with the recent reduction in size and increase in functionality of electronic apparatuses, higher circuit densities and decreases in thickness are strongly desired in such printed circuit boards. In particular, it is an important task in the field of printed circuit boards to establish a method for forming microcircuits, for example, with a line/space of 20 μm/20 μm or less.

In a printed circuit board, usually, adhesion between a circuit and a polymeric film serving as a substrate is achieved by surface irregularities, which is referred to as an anchoring effect. Therefore, a step of roughening a surface of a film is generally carried out, and the surface typically has a surface roughness of about 3 to 5 μm in terms of Rz. Such irregularities of the surface of the substrate do not cause a problem when the line/space of a circuit to be formed is 30/30 μm or more. However, in particular, when a circuit with a line width of 20/20 μm or less is formed, significant problems are caused. The reason for this is that such a fine circuit line with a high density is affected by the irregularities of the surface of the substrate. Consequently, in the formation of a circuit with a line/space of 20/20 μm or less, a technique for forming a circuit on a polymeric substrate with high smoothness is required. The smoothness must be 2 μm or less in terms of Rz, and preferably 1 μm or less. Naturally, in this case, the anchoring effect is not expected as adhesion force. Therefore, another method for bonding must be developed.

Furthermore, in a printed circuit board for forming a circuit, it is necessary to form via holes that electrically connect both surfaces of the circuit board. Consequently, in such a printed circuit board, a method of forming a circuit includes a step of forming via holes using laser, a desmearing step, a catalyst application step, an electroless copper plating step, etc. Moreover, circuit formation may be performed by a subtractive process using etching, or may be performed by a semiadditive process or an additive process. For example, in the semiadditive process, a method for forming fine lines includes a step of forming a plating resist film on an electroless copper plating layer, a step of forming a electrolytic copper plating layer on the electroless copper plating layer, a step of removing the plating resist film, and a step of etching an exposed portion of the electroless copper plating layer. Consequently, in the printed circuit board in which the fine lines described above are formed, adhesiveness between the wiring circuit and the polymeric film must be sufficient to withstand these steps.

With respect to improvement in adhesiveness between a resin layer with low surface roughness and a metal thin film formed on the surface of the resin layer by a physical method, such as sputtering or vapor deposition, several attempts have been made. For example, Japanese Patent No. 1,948,445 (U.S. Pat. No. 4,742,099) discloses a process in which an organotitanium compound is incorporated into a polyimide film. Japanese Unexamined Patent Application Publication No. 6-73209 (U.S. Pat. No. 5,227,224) discloses a process in which adhesion is improved by coating of a metal salt including Sn, Cu, Zn, Fe, Co, Mn, or Pd. U.S. Pat. No. 5,130,192 discloses a process in which after a heat-resistant surface treating agent is applied to a surface of a solidified film composed of a polyamic acid, imidization is performed, and the resulting polyimide film is metallized. Furthermore, Japanese Unexamined Patent Application Publication No. 11-71474 (Publication Date: Mar. 16, 1999) discloses a process in which elemental titanium is allowed to be present on a surface of a polyimide film.

A copper metal layer formed by a physical method, such as vapor deposition or sputtering, on the surface of any of the polyimide films described above has higher adhesion strength than a copper metal layer formed on the surface of an ordinary polyimide film. However, the metal layer is susceptible to desmearing and an electroless plating process, and adhesion strength is often decreased. In the actual process, the process window may become extremely narrow in some cases.

Furthermore, Japanese Unexamined Patent Application Publication No. 2002-113812 (Publication Date: Apr. 16, 2002) discloses a process which is developed by the present inventors and in which a conductive layer is formed by dry plating on a surface of a thermoplastic polyimide, and the conductive layer and the polyimide are bonded to each other by application of pressure and heat treatment so that adhesion strength between the polyimide and an adhesive layer is increased. This process has a different approach from the present invention.

On the other hand, in order to achieve strong adhesion between a metal foil and a polyimide resin, a method is used in which the surface of a copper metal foil is treated in advance. For example, Gi Xue, et al., “Adhesion Promotion at High Temperature for Epoxy Resin or polyimide onto Metal by a Two-Component Coupling System of Polybenzimidazole and 4-Aminophenyl disulfide”, Journal of Applied Polymer Science 1995, Vol. 58, p. 2221 reports a method in which the surface of a copper foil is treated with a polybenzimidazole solution and a 4-aminophenyl disulfide solution, subsequently, a film of a polyamic acid, which is a precursor of a polyimide resin, is formed, and the polyamic acid film is heated to produce a polyimide.

This method is suitable for circuit formation solely by a subtractive process because a surface-treated metal foil is used. However, this method is not applicable to a semiadditive process or an additive process that is effective in forming a high-density circuit of 20/20 μm or less, which is disadvantageous.

On the other hand, as a wet process used for printed circuit boards, i.e., a process in which an electroless plating film is directly formed on a resin material, Japanese Unexamined Patent Application Publication No. 2000-198907 (Publication Date: Jul. 18, 2000) discloses a process in which an electroless plating film is formed on a roughened surface of an epoxy resin.

However, although bonding is performed satisfactorily at a surface roughness Rz of 3 μm or more, it is known that only an adhesiveness of about 3 N/cm is exhibited at a surface roughness Rz below 3 μm, in particular, at about 1 μm. Thus, improvement in the process is required.

Meanwhile, as a process for forming an electroless plating film directly on a polyimide resin, Japanese Unexamined Patent Application Publication No. 2002-208768 (Publication Date: Jul. 26, 2002) discloses a process in which a polyimide resin is treated in a solution containing caustic alkali with a primary amino group-containing organic disulfide compound and/or a primary amino group-containing organic thiol compound.

However, adhesion strength between the electroless plating film obtained by this process and the polyimide resin is still insufficient.

On the other hand, as described in “Jikken Kagaku Koza (Courses in Experimental Chemistry) 24” edited by the Chemical Society of Japan, Maruzen, Sep. 25, 1992, p. 320, hydrogen sulfide and thiol compounds are known to form stable salts by reaction with a metal and a metallic compound.

A process in which, using this phenomenon, a surface of a metal is treated with a thiol derivative, in particular, a triazine thiol derivative to improve adhesiveness is disclosed, for example, in Japanese Unexamined Patent Application Publication No. 2001-1445 (Publication Date: Jan. 9, 2001), Japanese Unexamined Patent Application Publication No. 10-237047 (Publication Date: Sep. 8, 1998), and Japanese Unexamined Patent Application Publication No. 2000-160392 (Publication Date: Jun. 13, 2000).

Furthermore, Japanese Unexamined Patent Application Publication No. 2000-159933 (Publication Date: Jun. 13, 2000) and Japanese Unexamined Patent Application Publication No. 09-71664 (Publication Date Mar. 18, 1997) disclose, for example, treatment on a magnesium alloy, a method of bonding between rubber and a metal plating layer, etc.

However, application of these bonding techniques using a triazine thiol derivative in a manufacturing process of a printed circuit board has not been attempted. In particular, application of these bonding techniques in a manufacturing process of a printed circuit board using a polyimide, which is an important base for printed circuit boards, has not been attempted.

That is, in the past, a manufacturing process has not been developed in which strong adhesiveness is exhibited in an extremely smooth surface of a polyimide resin, the surface having a surface roughness Rz of 1 μm or less, and which can satisfactorily withstand a wet process that is an ordinary process for manufacturing printed circuit boards.

Furthermore, a manufacturing process of a printed circuit board usually includes several steps, and in the printed circuit board provided with fine lines, adhesiveness between the wiring circuit and the polymeric film must be sufficient to withstand these steps as described above. For practical use, even under high-temperature, high-humidity conditions, adhesiveness between the electroless plating layer and the insulating layer must be sufficiently high.

In the case of formation of fine lines, unless the irregularities of the surface of the insulating layer are decreased as much as possible, it is not possible to satisfactorily form lines in a designed shape with designed line width and thickness. Consequently, in the insulating layer most desirable for formation of fine lines, the irregularities of the surface are extremely small, and adhesiveness with the electroless plating layer which constitutes lines is satisfactorily high not only in the normal state but also under high-temperature, high-humidity conditions.

However, in the conventional techniques described above, there has not been found a manufacturing method of a printed circuit board in which satisfactory adhesion with lines is obtained and adhesion can be maintained even in a high-temperature, high-humidity environment, with surface irregularities being decreased or without particularly forming surface irregularities and without using a cumbersome method.

The present invention has been achieved to improve the problems described above. It is an object of the present invention to provide a polyimide resin composition, a polymeric film including the polyimide resin composition, a laminate including the polymeric film, and a printed circuit board. The polyimide resin composition allows resistance characteristics to be achieved when a metal circuit with a fine line width having strong adhesion is formed on an extremely smooth surface of the polymeric film or the laminate, and the metal circuit is formed by the ordinary manufacturing process of printed circuit board.

It is another object of the present invention to provide a method for manufacturing a printed circuit board, which is characterized in that when fine lines are formed on a surface of an insulating layer having extremely low surface smoothness (surface roughness), satisfactory adhesion strength is obtained between the insulating layer and an electroless plating layer constituting the lines not only in the normal state but also under high-temperature, high-humidity conditions.

### DISCLOSURE OF INVENTION

The present invention can achieve the objects described above by a novel polyimide resin composition, a polymeric film, a laminate, a printed circuit board, and a method for manufacturing a printed circuit board which will be described below.

1. A polyimide resin composition including at least an organic thiol compound and a thermoplastic polyimide resin.

2. The polyimide resin composition according to item 1, wherein the organic thiol compound is an organic dithiol compound and/or an organic trithiol compound.

3. The polyimide resin composition according to item 2, wherein the organic dithiol compound and/or the organic trithiol compound is a triazine thiol derivative.

4. The polyimide resin composition according to any one of items 1 to 3, wherein the thermoplastic polyimide is a polyimide resin obtained from a polyamic acid represented by general formula (1): 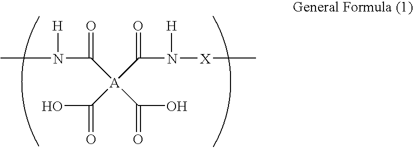
(wherein A represents a tetravalent organic group, and X represents a divalent organic group).

5. The polyimide resin composition according to item 4, wherein A in general formula (1) is at least one tetravalent organic group selected from group (1):

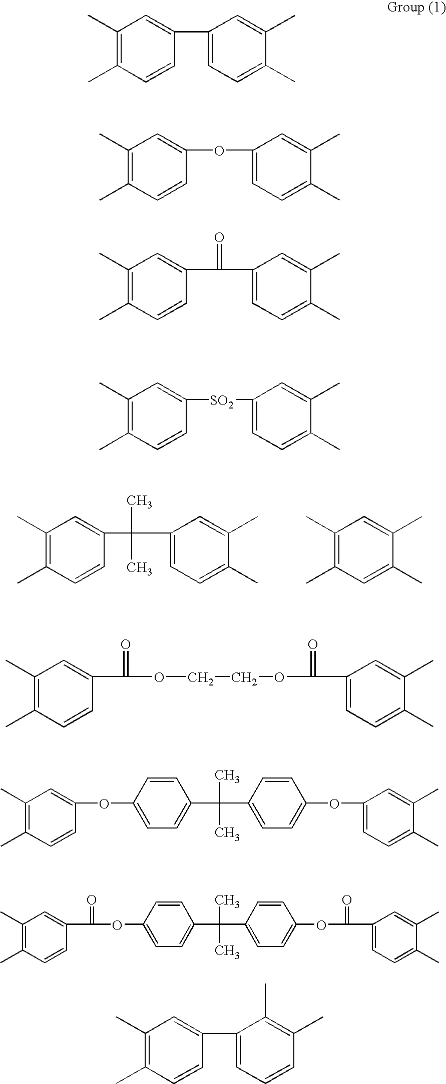

6. The polyimide resin composition according to item 4 or 5, wherein X in general formula (1) is at least one divalent organic group selected from group (2):

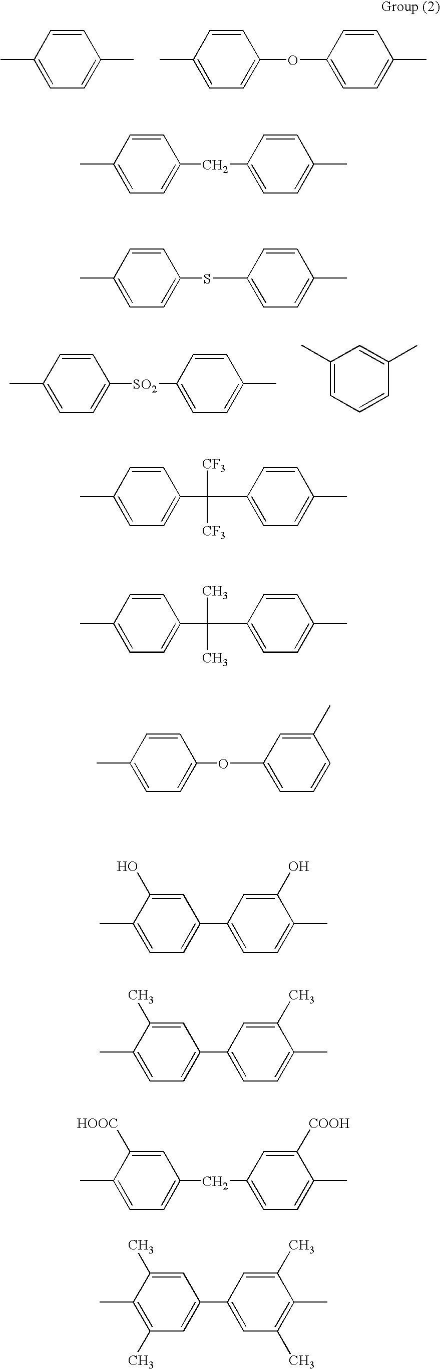

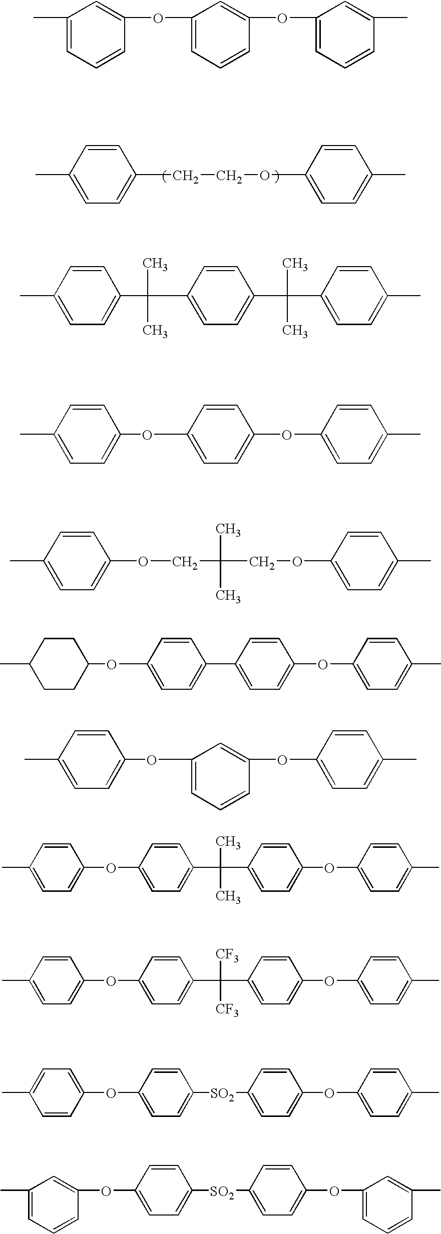

7. A polymeric film containing at least an organic thiol compound and a polyimide resin.

8. The polymeric film according to item 7, wherein the organic thiol compound is an organic dithiol compound and/or an organic trithiol compound.

9. The polymeric film according to item 8, wherein the organic dithiol compound and/or the organic trithiol compound is a triazine thiol derivative.

10. The polymeric film according to any one of items 7 to 9, wherein the polymeric film containing the polyimide resin is a non-thermoplastic polyimide film.

11. The polymeric film according to any one of items 7 to 9, wherein the polymeric film containing the polyimide resin is a single layer film containing a thermoplastic polyimide resin and the organic thiol compound.

12. The polymeric film according to any one of items 7 to 9, wherein the polymeric film containing the polyimide resin is a film including a layer containing a thermoplastic polyimide resin disposed on one surface or both surfaces of a support composed of a resin selected from the group consisting of non-thermoplastic polyimide resins, polyamide-imide resins, polyetherimide resins, polyamide resins, aromatic polyester resins, polycarbonate resins, polyacetal resins, polysulfone resins, polyethersulfone resins, polyethylene terephthalate resins, phenylene ether resins, polyolefin resins, polyarylate resins, liquid crystal polymers, and epoxy resins.

13. The polymeric film according to item 11 or 12, wherein the organic thiol compound is carried on the surface of the thermoplastic polyimide resin by dipping the thermoplastic polyimide resin in a solvent dissolving the organic thiol compound.

14. A polymeric film/metal foil laminate including a layer containing a thermoplastic polyimide resin on a surface thereof, wherein the polymeric film is the polymeric film according to item 11 or 12.

15. The polymeric film/metal foil laminate according to item 14, wherein the organic thiol compound is carried on the surface of the thermoplastic polyimide resin by dipping the thermoplastic polyimide resin in a solvent dissolving the organic thiol compound.

16. A polymeric film/adhesive layer laminate including a layer containing a thermoplastic polyimide resin on a surface thereof, wherein the polymeric film is the polymeric film according to item 11 or 12.

17. The polymeric film/adhesive layer laminate according to item 16, wherein the organic thiol compound is carried on the surface of the thermoplastic polyimide resin by dipping the thermoplastic polyimide resin in a solvent dissolving the organic thiol compound.

18. A laminate including the polymeric film according to any one of items 7 to 13 and a metal film formed by electroless plating on at least one surface of the polymeric film.

19. A laminate including the polymeric film according to any one of items 7 to 13 and a metal film formed by a physical method on at least one surface of the polymeric film.

20. A laminate including the laminate according to any one of items 14 to 17 and a metal film formed by electroless plating on the layer containing the thermoplastic polyimide resin of the laminate.

21. A laminate including the laminate according to any one of items 14 to 17 and a metal film formed by a physical method on the layer containing the thermoplastic polyimide resin of the laminate.

22. A printed circuit board including the polymeric film according to any one of items 7 to 13.

23. A printed circuit board including the laminate according to any one of items 14 to 17.

24. A method for manufacturing a printed circuit board including a step of forming at least an electroless plating layer on an insulating layer which contains a thermoplastic resin and which has a surface roughness of less than 0.05 μm in terms of arithmetic average roughness Ra measured with a cutoff value of 0.002 mm.

25. A method for manufacturing a printed circuit board including a step of forming an insulating layer on an inner circuit surface having an inner circuit layer of an inner circuit board, the insulating layer containing at least a thermoplastic resin and having a surface roughness of less than 0.05 μm in terms of arithmetic average roughness Ra measured with a cutoff value of 0.002 mm, a step of forming a via hole that passes through a region of the insulating layer on the inner circuit layer, a step of forming an electroless plating layer inside the via hole and on the insulating layer, a step of forming a patterned electrolytic plating layer on the electroless plating layer, and a step of removing an exposed portion of the electroless plating layer.

26. The method for manufacturing the printed circuit board according to item 24 or 25, further including a step of heat-treating at least the insulating layer and the electroless plating layer after the step of forming the electroless plating layer.

27. The method for manufacturing the printed circuit board according to any one of items 24 to 26, wherein the thermoplastic resin layer contains an organic thiol compound.

28. The method for manufacturing the printed circuit board according to item 26, wherein, in the step of heat-treating the insulating layer and the electroless plating layer, the heating temperature is equal to or higher than the glass transition temperature of the insulating layer.

29. The method for manufacturing the printed circuit board according to item 26 or 27, wherein, in the step of heat-treating the insulating layer and the electroless plating layer, the heating temperature is 300° C. or less.

### BRIEF DESCRIPTION OF THE DRAWINGS

FIG. 1 is a flow sheet illustrating a method for manufacturing a printed circuit board in an example of the present invention.

FIG. 2 is a flow sheet illustrating a method for manufacturing a printed circuit board in an example of the present invention.

### REFERENCE NUMERALS

11, 21 insulating layer
12, 22 electroless plating layer
13, 23 electrolytic plating layer
15, 25 wiring layer
22a exposed portion
24 plating resist film
30 inner circuit board
31 inner circuit surface
35 inner circuit layer
101, 102, 103, 201, 202, 203 heat treatment

### BEST MODE FOR CARRYING OUT THE INVENTION

The present invention provides an insulating material, for example, used for printed circuit boards, the insulating material having strong adhesion to a metal line even if the surface of the insulating material is smooth, and withstanding the manufacturing process of ordinary printed circuit boards, and provides a printed circuit board and a method for manufacturing the same. Specifically, the characteristics described above can be achieved by using, as the insulating material, a polyimide resin composition including at least an organic thiol compound and a thermoplastic polyimide resin.

Furthermore, specifically, the characteristics described above can be achieved by using, as the insulating material, a polymeric film including at least an organic thiol compound and a polyimide resin.

Furthermore, the characteristics described above can be achieved by using a method for manufacturing a printed circuit board including a step of forming at least an electroless plating layer on an insulating layer which contains a thermoplastic resin and which has a surface roughness of less than 0.05 μm in terms of arithmetic average roughness Ra measured with a cutoff value of 0.002 mm. By employing this method, furthermore, when fine lines are formed on a surface of an insulating layer having extremely low surface smoothness (surface roughness), satisfactory adhesion strength is obtained between the insulating layer and an electroless plating layer not only in the normal state but also under high-temperature, high-humidity conditions.

The polyimide resin composition, the polymeric film and laminates including the same, and the printed circuit board and the method for manufacturing the same will be described in detail below.

(Polyimide Resin Composition)

A polyimide resin composition of the present invention includes at least an organic thiol compound and a thermoplastic polyimide resin. In accordance with a method for manufacturing a printed circuit board in the past, in a step of forming an electroless plating film on an insulating layer (polymeric film), a palladium catalyst carried for forming the electroless plating film is only chemically adsorbed on a surface of the polymeric film. However, by using the polyimide resin composition of the present invention for a polymeric film or a laminate, a catalyst is carried by strong adhesion force, and as a result, an electroless plating film in which strong adhesion is achieved is formed. The reason for this is assumed to be that, through the organic thiol compound, chemical bonding between the polyimide resin composition and a metal and/or a catalyst is strengthened. Although it has been known that the organic thiol compound has strong adhesion to a metal, the present inventors have found that particularly strong adhesion can be obtained between a polyimide resin and a metal. The present inventors have also found that, by utilizing this characteristic, if the polyimide resin composition is, for example, used as an electronic material for a printed circuit board and the like, it is possible to strengthen adhesion with a metal line while maintaining physical properties, such as heat resistance.

In the polyimide resin composition of the present invention, the organic thiol compound is incorporated into the thermoplastic polyimide resin or the organic thiol compound is carried on the surface of the thermoplastic polyimide resin. Furthermore, the polyimide resin composition of the present invention includes at least an organic thiol compound and a thermoplastic polyimide resin as described above, and the polyimide resin composition may include a component other than the organic thiol compound and the thermoplastic polyimide resin.

<Thermoplastic Polyimide Resin>

A thermoplastic polyimide resin in the polyimide resin composition of the present invention can be produced by a known process. That is, the thermoplastic polyimide resin can be obtained by chemically or thermally imidizing a polyamic acid which is a precursor of the polyimide. The polyamic acid which is a precursor of the polyimide resin used in the present invention can be produced usually by a process in which using at least one acid dianhydride and at least one diamine as starting materials, substantially equimolar amounts of both components are dissolved in an organic solvent, and the resulting solution is stirred under controlled reaction conditions, such as temperature, until polymerization is completed. Herein, the thermoplastic polyimide is different from a non-thermoplastic polyimide which is, for example, synthesized from pyromellitic dianhydride and oxydianiline, and has a glass transition temperature.

The acid dianhydride for producing such a thermoplastic polyimide is not particularly limited. Preferably used is at least one acid dianhydride selected from tetracarboxylic dianhydrides, such as pyromellitic dianhydride, 3,3′,4,4′-benzophenonetetracarboxylic dianhydride, bis(3,4-dicarboxyphenyl)sulfonic dianhydride, 2,2′,3,3′-biphenyltetracarboxylic dianhydride, 3,3′,4,4′-biphenyltetracarboxylic dianhydride, oxydiphthalic dianhydride, bis(2,3-dicarboxyphenyl)methane dianhydride, bis(3,4-dicarboxyphenyl)methane dianhydride, 1,1-bis(2,3-dicarboxyphenyl)ethane dianhydride, 1,1-bis(3,4-dicarboxyphenyl)ethane dianhydride, 1,2-bis(3,4-dicarboxyphenyl)ethane dianhydride, 2,2-bis(3,4-dicarboxyphenyl)propane dianhydride, 1,3-bis(3,4-dicarboxyphenyl)propane dianhydride, 4,4′-hexafluoroisopropylidenediphthalic anhydride, 1,2,5,6-naphthalenetetracarboxylic dianhydride, 2,3,6,7-naphthalenetetracarboxylic dianhydride, 3,4,9,10-perylenetetracarboxylic dianhydride, p-phenylenebis(trimellitic acid monoester anhydride), ethylenebis(trimellitic acid monoester anhydride), bisphenol A bis(trimellitic acid monoester anhydride), 4,4′-(4,4′-isopropylidenediphenoxy)bis(phthalic anhydride), and p-phenylenediphthalic anhydride.

Furthermore, the diamine for producing the thermoplastic polyimide is also not particularly limited. Preferably used is at least one diamine selected from the group consisting of 1,4-diaminobenzene(p-phenylenediamine), 1,3-diaminobenzene, 1,2-diaminobenzene, benzidine, 3,3′-dichlorobenzidine, 3,3′-dimethylbenzidine, 3,3′-dimethoxybenzidine, 3,3′-dihydroxybenzidine, 3,3′,5,5′-tetramethylbenzidine, 4,4′-diaminodiphenylpropane, 4,4′-diaminodiphenylhexafluoropropane, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl-N-methylamine, 4,4′-diaminodiphenyl-N-phenylamine, 4,4′-diaminodiphenyl ether, 3,4′-diaminodiphenyl ether, 3,3′-diaminodiphenyl ether, 4,4′-diaminodiphenyl thioether, 3,4′-diaminodiphenyl thioether, 3,3′-diaminodiphenyl thioether, 3,3′-diaminodiphenylmethane, 4,4′-diaminodiphenyl sulfone, 3,4′-diaminodiphenyl sulfone, 3,3′-diaminodiphenyl sulfone, 4,4′-diaminobenzanilide, 3,4′-diaminobenzanilide, 3,3′-diaminobenzanilide, 4,4′-diaminobenzophenone, 3,4′-diaminobenzophenone, 3,3′-diaminobenzophenone, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 1,3-bis(3-aminophenoxy)benzene, 1,4-bis(3-aminophenoxy)benzene, 1,4′-bis(4-aminophenoxy)benzene, 4,4′-bis(4-aminophenoxy)biphenyl, 4,4′-bis(3-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenyl ether, 4,4′-bis[3-(3-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenyl sulfone, bis[4-{4-(4-aminophenoxy)phenoxy}phenyl]sulfone, 1,4-bis[4-(4-aminophenoxy)-α,α-dimethylbenzyl]benzene, 1,3-bis[4-(4-aminophenoxy)-α,α-dimethylbenzyl]benzene, 4,4′-diaminodiphenylethylphosphine oxide, and 4,4′-diamino-3,3′-dicarboxydiphenylmethane.

The thermoplastic polyimide used in the present invention is preferably a thermoplastic polyimide obtained by cyclodehydration of a polyamic acid represented by general formula (1): 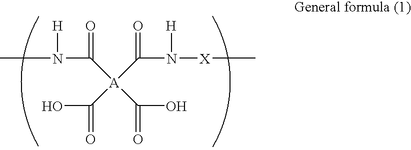
(wherein A represents a tetravalent organic group, and X represents a divalent organic group).

Furthermore, A in general formula (1) is more preferably at least one tetravalent organic group selected from group (1): 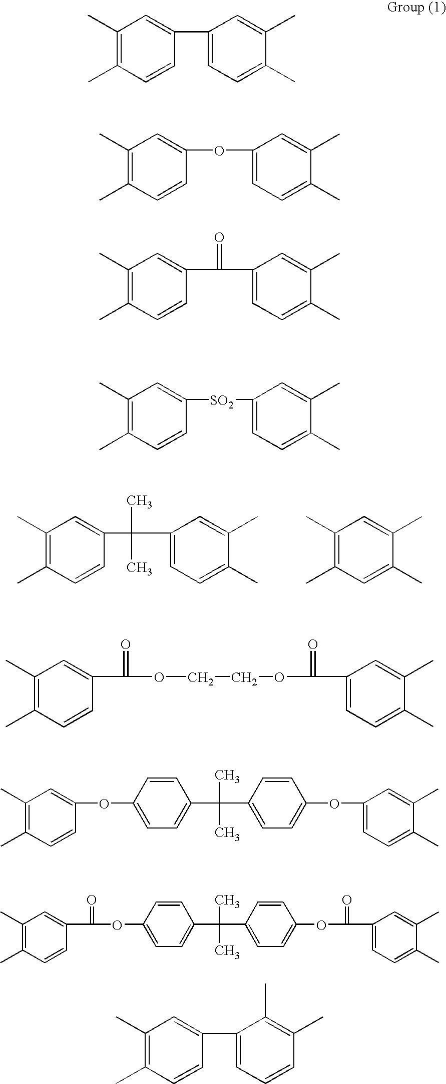
Furthermore, X in general formula (1) is more preferably one or at least two organic groups selected from group (2):

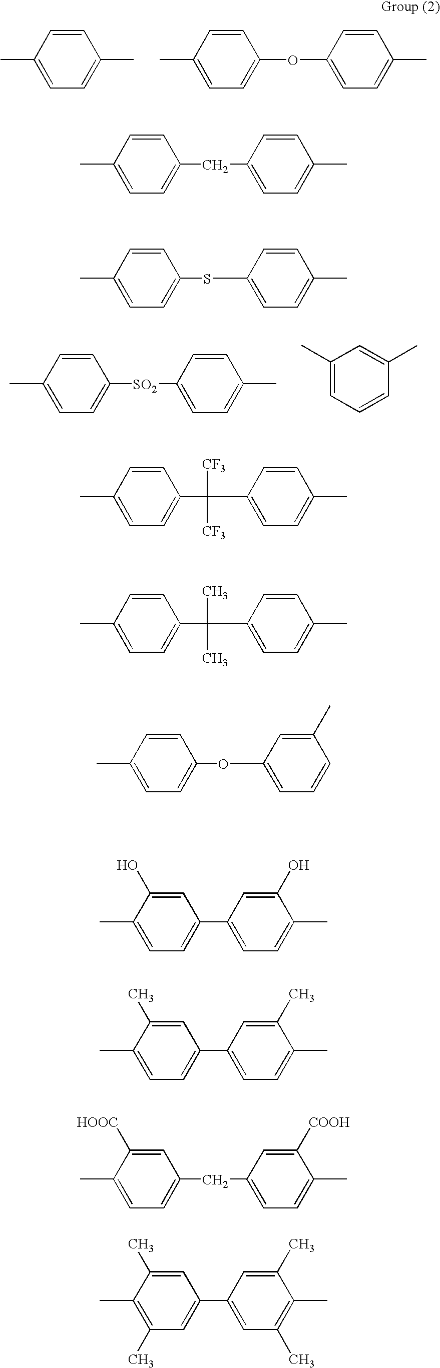

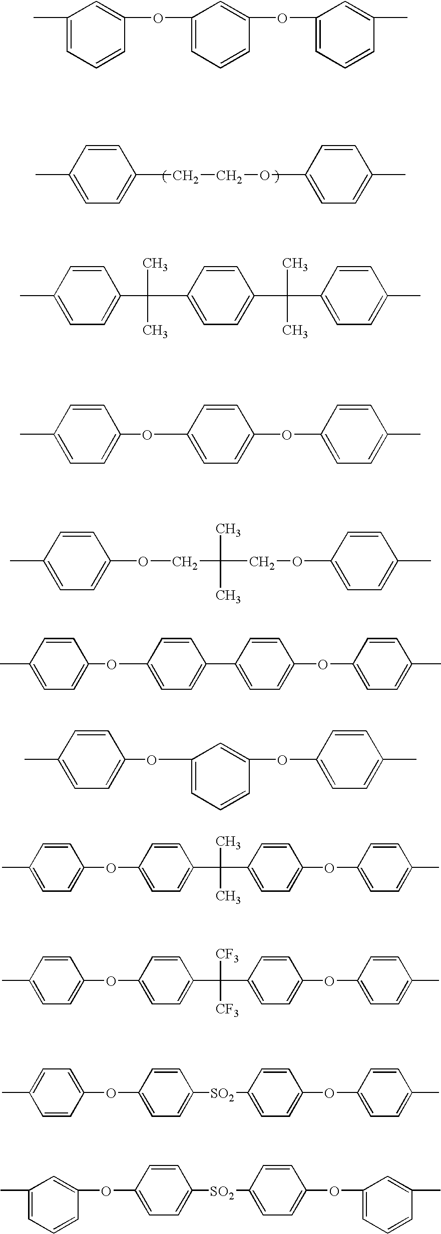

Thus, the resulting thermoplastic polyimide has excellent characteristics, such as low coefficient of water absorption, low dielectric constant, and small dielectric loss tangent. Moreover, the effect of increasing adhesion strength to an electroless plating film, which is the advantage of the present invention, can be exhibited.

As the combination of the acid dianhydride and the diamine for obtaining the thermoplastic polyimide resin, preferred is a combination of at least one acid dianhydride selected from acid dianhydrides providing the acid dianhydride moieties exemplified in group (1) and at least one diamine selected from diamines providing the diamine moieties exemplified in group (2). Among these, particularly preferably usable examples of the acid dianhydride include 2,3,3′,4′-biphenyltetracarboxylic dianhydride, 3,3′,4,4′-biphenyltetracarboxylic dianhydride, oxydiphthalic dianhydride, ethylenebis(trimellitic acid monoester anhydride), bisphenol A bis(trimellitic acid monoester anhydride), and 4,4′-(4,4′-isopropylidenediphenoxy)bis(phthalic anhydride), and particularly preferably usable examples of the diamine include 1,3-diaminobenzene, 3,4′-diaminodiphenyl ether, 4,4′-diaminodiphenyl ether, 1,3-bis(3-aminophenoxy)benzene, 1,3-bis(4-aminophenoxy)benzene, 1,4-bis(4-aminophenoxy)benzene, 2,2-bis[4-(4-aminophenoxy)phenyl]propane, 4,4′-bis(4-aminophenoxy)biphenyl, bis[4-(4-aminophenoxy)phenyl]sulfone, 4,4′-diamino-3,3′-dicarboxydiphenylmethane, and 3,3′-dihydroxybenzidine, from the standpoints that the resulting thermoplastic polyimide has excellent characteristics, such as low water absorption, low dielectric constant, and small dielectric loss tangent and that the effect of increasing adhesion strength to an electroless plating film, which is the advantage of the present invention, is exhibited.

The thermoplastic polyimide resin can be produced by a known process. That is, the thermoplastic polyimide resin can be obtained by chemically or thermally imidizing a polyamic acid which is a precursor of the polyimide. The polyamic acid which is the precursor of the polyimide resin used in the present invention can be produced usually by a process in which using at least one acid dianhydride and at least one diamine as starting materials, substantially equimolar amounts of both components are dissolved in an organic solvent, and the resulting solution is stirred under controlled reaction conditions, such as temperature, until polymerization is completed.

In a typical procedure of polymerization reaction, at least one diamine component is dissolved or dispersed in a polar organic solvent, and then at least one acid dianhydride component is added thereto to prepare a polyamic acid solution. The order of adding the individual monomers is not particularly limited. The polyamic acid polymer solution may be prepared by adding an acid dianhydride component into a polar organic solvent first, and then adding a diamine component thereto. Alternatively, the polyamic acid polymer solution may be prepared by adding an adequate amount of a diamine component into a polar organic solvent first, adding an acid dianhydride component thereto in excess of the diamine component, and then adding the diamine component in an amount corresponding to the excess amount of the added acid dianhydride component. Besides these processes, various addition processes known to those skilled in the art may be employed. Herein, the term “dissolved” means not only a state in which a solvent completely dissolves a solute but also a state in which a solute is uniformly dispersed in a solvent and which is substantially the same as the dissolved state.

Examples of the polar organic solvent which may be used in the polymerization reaction of the polyamic acid include sulfoxide solvents, such as dimethyl sulfoxide and diethyl sulfoxide; formamide solvents, such as N,N-dimethylformamide and N,N-diethylformamide; acetamide solvents, such as N,N-dimethylacetamide and N,N-diethylacetamide; pyrrolidone solvents, such as N-methyl-2-pyrrolidone; phenol solvents, such as phenol, o-cresol, m-cresol, p-cresol, xylenol, halogenated phenol, and catechol; hexamethylphosphoramide; and γ-butyrolactone. Furthermore, as necessary, any of the polar organic solvents and an aromatic hydrocarbon, such as xylene or toluene, may be combined for use.

The polyamic acid prepared as described above is cyclodehydrated by a thermal method or a chemical method to produce a thermoplastic polyimide. Either the thermal method in which the polyamic acid solution is dehydrated by heat treatment or the chemical method in which the polyamic acid solution is dehydrated with a dehydrating agent may be used. Furthermore, a method in which imidization is carried out by heating under reduced pressure may also be used. The individual methods will be described below.

In one example of the thermal cyclodehydration method, imidization is allowed to proceed by heat treatment of the polyamic acid solution and at the same time the solvent is evaporated, etc. By this method a solid thermoplastic polyimide resin can be obtained. The heat treatment conditions are not particularly limited. Preferably, the heat treatment is performed at 500° C. or less for about 5 to 200 minutes.

In one example of the chemical cyclodehydration method, dehydration reaction is performed by adding a stoichiometric amount or more of a dehydrating agent to the polyamic acid solution, and evaporation of the solvent, etc. is performed. By this method a solid thermoplastic polyimide resin can be obtained. Examples of the dehydrating agent which may be used in the chemical method include aliphatic acid anhydrides, such as acetic anhydride; aromatic acid anhydrides, such as benzoic anhydride; and carbodiimide compounds, such as dicyclohexylcarbodiimide. In the chemical cyclodehydration method, a catalyst may also be used. Examples of the catalyst include aliphatic tertiary amines, such as triethylamine; aromatic tertiary amines, such as dimethylaniline; and heterocyclic tertiary amines, such as pyridine, α-picoline, β-picoline, γ-picoline, and isoquinoline. The chemical cyclodehydration is preferably performed at 100° C. or less, and the evaporation of the organic solvent is preferably performed at 200° C. or less for about 5 to 120 minutes.

As another method for producing a polyimide resin, the thermal or chemical cyclodehydration method excluding the evaporation of the solvent may also be mentioned. Specifically, the thermoplastic polyimide resin solution obtained by thermal imidization treatment or chemical imidization treatment using a dehydrating agent is added to a poor solvent to precipitate the thermoplastic polyimide resin, unreacted monomers are removed, and purification and drying are performed to produce a solid thermoplastic polyimide. As the poor solvent, any solvent that mixes satisfactorily with the solvent but does not easily dissolve the polyimide can be selected. Examples thereof include acetone, methanol, ethanol, isopropanol, benzene, methyl cellosolve, and methyl ethyl ketone.

Furthermore, a method in which imidization is carried out by heating under reduced pressure may also be mentioned. In this imidization method, water generated during imidization can be actively removed out of the system. Therefore, hydrolysis of the polyamic acid polymer can be inhibited, and a high-molecular weight thermoplastic polyimide can be obtained.

In the thermal imidization method under reduced pressure, the heating temperature is preferably 80° C. to 400° C. From the standpoints of efficient imidization and efficient removal of water, the heating temperature is more preferably 100° C. or more, and still more preferably 120° C. or more. The reduced pressure is preferably lower. The pressure is preferably 1×10² Pa to 9×10⁴ Pa, and more preferably 1×10² Pa to 7×10⁴ Pa.

<Organic Thiol Compound>

The organic thiol compound of the present invention will now be described. The organic thiol compound used in the present invention is a compound having at least one SM group (wherein M represents any element selected from H, Li, Na, and K) per molecule. An organic thiol compound having two or more SM groups, such as an organic dithiol compound or an organic trithiol compound, is preferable. The reason for the preference of the compound having two or more SM groups is that at least one SM group forms a chemical bond with a thermoplastic polyimide resin, the other SM group binds to an electroless plating film, and thus strong adhesiveness is exhibited between the polyimide resin composition and the electroless plating film.

The organic thiol compound which may be used is not particularly limited as long as the object of the present invention is achieved. Examples of the organic monothiol include 2-mercaptopyridine, 2-mercaptopyrimidine, 2-mercaptobenzimidazole, 2-mercaptobenzothiazole, 2-mercaptobenzoxazole, 2-mercaptoethanol, 4-mercaptobutanol, and 5-methyl-1,3,4-thiazole-2-thiol.

Examples of the organic dithiol include 2,5-dimercapto-1,3,4-thiadiazole, 2,3-dimercapto-1-propanol, 2,6-dimercaptopurine, 2,5-dimercapto-1,3,4-thiadiazole dipotassium salts, 2-mercaptoethyl ether, and 2-mercaptoethyl sulfide.

Among them, a triazine dithiol derivative or a triazine trithiol derivative is preferably used as the organic thiol compound. Examples of the triazine dithiol derivative or the triazine trithiol derivative include 1,3,5-triazine-2,4,6-trithiol, and compounds represented by general formulae (2) and (3): 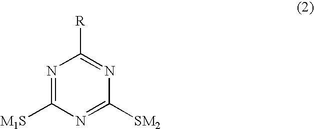
(wherein M1 and M2 each represent any element selected from H, Li, Na, K, and Ca; and R represents H, a saturated alkyl group having 1 to 18 carbon atoms, an unsaturated alkyl substituent, such as alkyne or alkene, having 1 to 18 carbon atoms, a phenyl group, an amino group, or a SH group) 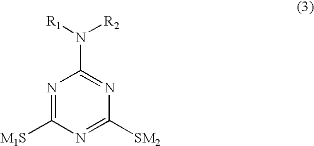
(wherein M1 and M2 each represent any element selected from H, Li, Na, K, and Ca; and R1 and R2 each represent H, a saturated alkyl group having 1 to 18 carbon atoms, an unsaturated alkyl substituent, such as alkyne or alkene, having 1 to 18 carbon atoms, a phenyl group, or an amino group).

Specifically, in general formulae (2) and (3), M1 can be exemplified by H, and M2 can be exemplified by H or Na. In general formula (2), R can be exemplified by H, C2H5, C4H9, or SH. In general formula (3), R1-N—R2 can be exemplified by N(CH3)2, NH(C6H5), N(C4H9)₂, N(C8H17)2, N(C12H25)2, N(CH2CH═CH2)2, NHC8H16CH═CHC8H17, NCH2C6H4CH═CH2(C8H17), or NHC6H4N(CH3)2.

<Other Components>

In addition to the thermoplastic resin described above, in order to improve characteristics, such as adhesiveness, heat resistance, and processability, other components may be added to the thermoplastic polyimide resin to an extent that does not impair characteristics, such as heat resistance and low water absorption. Examples of the other components include thermosetting resins, such as epoxy resins, cyanate ester resins, bismaleimide resins, bisallylnadiimide resins, phenol resins, acrylic resins, methacrylic resins, curable hydrosilyl resins, curable allyl resins, and unsaturated polyester resins; and reactive side-chain group-containing thermosetting polymers having reactive groups, such as an allyl group, a vinyl group, an alkoxysilyl group, or a hydrosilyl group, in side chains or in termini of the polymer chain. These may be used alone or in appropriate combination.

<Method for Addition of Organic Thiol Compound>

A method for adding the organic thiol compound to the thermoplastic polyimide resin will be described below. With respect to the method for adding the organic thiol compound to the thermoplastic polyimide resin, the addition may be performed in the form of a polyamic acid which is a precursor of the thermoplastic polyimide resin, or the addition may be performed using a solvent that dissolves the thermoplastic polyimide resin and the organic thiol compound. As the solvent, an amide solvent, such as N,N-dimethylformamide, N,N-dimethylacetamide, or N-methyl-2-pyrroline, is preferably used, and particularly preferably, N,N-dimethylformamide is used. With respect to the triazine thiol derivatives represented by general formulae (2) and (3), when at least one of M1 and M2 is an alkali metal, such as Na, the derivatives are often soluble in alkaline aqueous solutions and alkaline methanol. These solvents are also preferably used when the triazine thiol derivative is added to the thermoplastic polyimide resin. The amount of addition of the organic dithiol compound is preferably 10% by weight or less, and more preferably 2% by weight or less, relative to the thermoplastic polyimide resin. Even at an amount of addition of 1% by weight or less, the effect is sufficiently exhibited. Even at 0.01% by weight, the effect can be recognized. Even at 0.001% by weight, the effect may be confirmed in some cases. As described above, by adding the organic thiol compound to the thermoplastic polyimide resin, it is possible to obtain a polyimide resin composition which is usable for molded objects, single layer films, laminates each including a thermoplastic polyimide resin layer disposed on a support, and the like.

When the polyimide resin composition is used as a film, the organic thiol compound may be carried on the surface of the film. A method therefor will be described in the section (Polymeric film) below.

<Form of Polyimide Resin Composition>

The polyimide resin composition including at least the thermoplastic polyimide resin and the organic thiol compound can be used in various forms. For example, the polyimide resin composition may be used in the form of a solution containing the thermoplastic polyimide resin and the organic thiol compound. In use of the thermoplastic polyimide resin in the form of a solution, if the thermoplastic polyimide resin is solvent-soluble, an insulating layer can be formed by preparing a resin solution, and applying the resin solution by a known process, such as spin-coating, onto an inner circuit board, followed by drying.

Furthermore, the polyimide resin composition of the present invention may be used in the form of a polymeric film. In such a case, the polymeric film may be used as a single layer film composed of the polyimide resin composition of the present invention. Alternatively, the polymeric film may be used for a multilayer structure which includes a layer composed of the polyimide resin composition of the present invention disposed on one surface or both surfaces of a film composed of a specific resin.

Furthermore, a polymeric film including the resin composition of the present invention may be used in the form of a laminate. Specific examples thereof include a laminate including the polymeric film and a metal foil or an adhesive layer disposed on one surface of the polymeric film, a laminate including the polymeric film and a metal layer formed by electroless plating on one surface of the polymeric film, and a laminate including the polymeric film and a metal layer formed by a physical method on one surface of the polymeric film.

(Polymeric Film and Laminate Including the Same)

The polymeric film of the present invention contains at least an organic thiol compound and a polyimide resin. The organic thiol compound may be present in the film or may be carried on the surface of the film. As the polyimide resin, a non-thermoplastic resin may be used. However, use of the thermoplastic polyimide resin described above is preferable from the standpoint that adhesion with metal lines is further strengthened.

The polymeric film of the present invention may be a single layer film including only a layer containing at least an organic thiol compound and a thermoplastic polyimide resin. Alternatively, the polymeric film may be in the form of a multilayer structure in which a layer containing the thermoplastic polyimide resin is disposed on at least one surface of a support.

<Single Layer Film>

One example of the polymeric film of the present invention is a single layer film formed of a composition including at least a thermoplastic polyimide resin and an organic thiol compound. Furthermore, the polyimide resin composition is preferably surface-treated by dipping the thermoplastic polyimide resin in a solvent in which the organic thiol compound is dissolved or by allowing the organic thiol compound to be carried on the surface of the thermoplastic polyimide resin. The specific method for forming the single layer film is not particularly limited, and a known method may be used.

For example, there are several methods which may be used for forming the single layer film of the thermoplastic polyimide resin. When the thermoplastic polyimide resin is solvent-insoluble, preferably, a film is formed by a method in which a solution of a polyamic acid which is a precursor is applied by flow-casting onto a support in the form of a film, imidization is performed by the imidization method described above, i.e., the chemical imidization method or the thermal imidization method, and the solvent is dried. When the thermoplastic polyimide is solvent-soluble, besides the same method as that in the case of the insoluble thermoplastic polyimide resin, a film may be formed by a method in which a thermoplastic polyimide resin that has been prepared in the form of a powder, fiber, or film, is dissolved in a solvent, and the resulting thermoplastic polyimide solution is applied by flow-casting onto a support in the form of a film.

<Polymeric Film with Multilayer Structure>

Another example of the polymeric film of the present invention is a film with a multilayer structure obtained by disposing a layer composed of a resin composition including a thermoplastic polyimide resin and an organic thiol compound on a support. When the polyimide resin-composition of the present invention is, for example, used for printed circuit boards, preferably used is a film with a multilayer structure including a layer composed of the polyimide resin composition of the present invention (hereinafter also referred to simply as a “thermoplastic polyimide resin layer”) and a support as described above in (Polyimide resin composition). The reason for the preference of use of the film with the multilayer structure is that characteristics, such as low thermal expansion, high modulus, and heat resistance, are imparted to printed circuit boards by the use of the film with the multilayer structure. The film with the multilayer structure can be formed by applying the polyimide resin composition onto a support. The support is not particularly limited, and examples of the material for the support which may be used include polyamide-imide resins, polyetherimide resins, polyamide resins, aromatic polyester resins, polycarbonate resins, polyacetal resins, polysulfone resins, polyethersulfone resins, polyethylene terephthalate resins, phenylene ether resins, polyolefin resins, polyarylate resins, liquid crystal polymers, and epoxy resins. In particular, when a polymeric film is used as the support, the polymeric film is preferably composed of a non-thermoplastic polyimide resin. That is, a film with a multilayer structure including a thermoplastic polyimide resin layer and a layer composed of a non-thermoplastic polyimide resin (hereinafter referred to as a “non-thermoplastic polyimide resin layer”) is most preferable in view of heat resistance, dimensional stability, interfacial adhesion, etc. In particular, use of a non-thermoplastic polyimide resin as the support is preferable because the average coefficient of thermal expansion can be decreased, which is an important characteristic of printed circuit boards. Hereinafter, the film with the multilayer structure may be referred to as a laminate.

Furthermore, hereinafter, a laminate in which a thermoplastic polyimide resin layer is disposed on a non-thermoplastic polyimide resin layer is noted as “thermoplastic polyimide resin layer/non-thermoplastic polyimide resin layer”, a laminate in which thermoplastic polyimide resin layers are disposed on both surfaces of a non-thermoplastic polyimide resin layer is noted as “thermoplastic polyimide resin layer/non-thermoplastic polyimide resin layer/thermoplastic polyimide resin layer”, and the like. In the case in which the thermoplastic polyimide resin layer is replaced, for example, by a metal layer or an adhesive layer, the same notation is used.

<Non-Thermoplastic Polyimide Resin>

The non-thermoplastic polyimide resin used for the laminate is not particularly limited. A known non-thermoplastic polyimide resin can be used as long as it satisfies heat resistance, dimensional stability, and interfacial adhesion of the polyimide resin composition. A known process can be used for producing the non-thermoplastic polyimide resin.

As the precursor of the non-thermoplastic polyimide resin, a known polyamic acid can be used. The polyamic acid can be prepared by a process in which substantially equimolar amounts of at least one acid dianhydride compound and at least one diamine compound are dissolved in an organic solvent and allowed to react with each other. The non-thermoplastic polyimide resin is obtained by imidization of the polyamic acid which is the precursor. The imidization may be performed using either a thermal cure method or a chemical cure method, or using both cure methods together.

Examples of the acid dianhydride compound used for the synthesis of the non-thermoplastic polyimide resin include pyromellitic dianhydride, oxydiphthalic dianhydride, 3,3′,4,4′-benzophenonetetracarboxylic dianhydride, 3,3′,4,4′-biphenyltetracarboxylic dianhydride, and p-phenylenebis(trimellitic acid monoester anhydride). These are preferably used alone or as a mixture at any desired ratio. Furthermore, examples of the diamine compound used for the synthesis of the non-thermoplastic polyimide resin include 4,4′-diaminodiphenyl ether, 4,4′-diaminobenzanilide, and p-phenylenediamine. These are preferably used alone or as a mixture at any desired ratio. Examples of the preferred combination of the acid dianhydride compound and the diamine compound used for the synthesis of the non-thermoplastic polyimide resin include a combination of pyromellitic dianhydride and 4,4′-diaminodiphenyl ether, a combination of pyromellitic dianhydride and 4,4′-diaminodiphenyl ether/p-phenylenediamine, a combination of pyromellitic dianhydride/p-phenylenebis(trimellitic acid monoester anhydride) and 4,4′-diaminodiphenyl ether/p-phenylenediamine, and a combination of 3,3′,4,4′-biphenyltetracarboxylic dianhydride and p-phenylenediamine. The non-thermoplastic polyimide resin synthesized using any combination of the acid dianhydride compound and the diamine compound described above exhibits excellent characteristics, such as moderate modulus of elasticity, dimensional stability, and low water absorption, and thus can be suitably used for various laminates composed of the polyimide resin composition of the present invention.

Additionally, the thickness of the non-thermoplastic polyimide resin layer is preferably 2 μm to 125 μm, and more preferably 5 μm to 75 μm. Furthermore, an inorganic or organic filler, a plasticizer, such as an organophosphorus compound, and an antioxidant may be added to the non-thermoplastic polyimide resin layer by a known method. By subjecting the non-thermoplastic polyimide resin layer to known physical surface treatment, such as corona discharge treatment, plasma discharge treatment, or ion gun treatment, and chemical surface treatment, such as primer treatment, satisfactory characteristics can be imparted.

<“Thermoplastic Polyimide Resin Layer/Non-Thermoplastic Polyimide Resin Layer” Laminate>

The “thermoplastic polyimide resin layer/non-thermoplastic polyimide resin layer” laminate can be produced by various methods. For example, when the thermoplastic polyimide resin is solvent-insoluble, a thermoplastic polyimide resin layer may be formed by a method in which a solution of a polyamic acid which is a precursor is applied by flow-casting onto a non-thermoplastic polyimide resin layer, imidization is performed by the imidization method described above, i.e., the chemical imidization method or the thermal imidization method, and the solvent is dried. On the other hand, when the thermoplastic polyimide is solvent-soluble, a thermoplastic polyimide resin layer may be formed by a method in which a thermoplastic polyimide resin that has been prepared in the form of a powder, fiber, or film, is dissolved in a solvent, and the resulting thermoplastic polyimide solution is applied by flow-casting onto a non-thermoplastic polyimide resin layer, and the solvent is dried. As in the case of the insoluble thermoplastic polyimide resin, a method in which a polyamic acid which is a precursor is applied by flow-casting onto a non-thermoplastic polyimide resin layer may also be used. It is also possible to produce the laminate by another method in which after a film composed of a thermoplastic polyimide resin is formed in advance, the film is attached onto a non-thermoplastic polyimide resin layer by a known process, such as pressing or laminating.

The thickness of the thermoplastic polyimide resin layer in each of various laminates is preferably as small as possible in order to exploit physical properties of the non-thermoplastic polyimide film which has various excellent characteristics as a circuit board, e.g., low thermal expansion, heat resistance, and electrical characteristics. That is, the thickness of the thermoplastic polyimide resin layer is preferably smaller than the thickness of the non-thermoplastic polyimide resin layer, more preferably a half or less of the thickness of the non-thermoplastic polyimide resin layer, and still more preferably one fifth or less of the thickness of the non-thermoplastic polyimide resin layer.

<“Thermoplastic Polyimide Resin Layer/Non-Thermoplastic Polyimide Resin Layer/Thermoplastic Polyimide Resin Layer” Laminate>

As the polymeric film, in addition to the “thermoplastic polyimide resin layer/non-thermoplastic polyimide resin layer” laminate described above, for example, a “thermoplastic polyimide resin layer/non-thermoplastic polyimide resin layer/thermoplastic polyimide resin layer” laminate can be used in which thermoplastic polyimide layers are formed on both surfaces of a non-thermoplastic polyimide resin layer.

<“Thermoplastic Polyimide Resin Layer/Non-Thermoplastic Polyimide Resin Layer/Metal Thin Layer” Laminate>

Furthermore, as the polymeric film, a “thermoplastic polyimide resin layer/non-thermoplastic polyimide resin layer/metal foil layer” laminate can be used, in which using the “thermoplastic polyimide resin layer/non-thermoplastic polyimide resin layer” laminate described above, a metal thin layer is formed on a surface of the non-thermoplastic polyimide resin layer opposite to the surface provided with the thermoplastic polyimide resin layer. The metal thin layer in the “thermoplastic polyimide resin layer/non-thermoplastic polyimide resin layer/metal thin layer” laminate may be, for example, a copper layer formed by wet plating. The metal thin layer may be a copper foil layer formed by directly bonding a copper foil with a roughened surface onto the non-thermoplastic polyimide resin layer (for example, a solution of a polyamic acid which is a precursor is applied by flow-casting onto a copper foil with appropriate surface roughness, imidization is performed by a thermal cure method or chemical cure method, and the solvent is dried to form a non-thermoplastic polyimide layer on the copper foil). Alternatively, the metal thin layer may be a copper foil layer, the copper foil layer being bonded to the non-thermoplastic polyimide resin layer with an appropriate adhesive therebetween. In the method of bonding the copper foil layer to the non-thermoplastic polyimide resin layer with the adhesive therebetween, a known process, such as thermal laminating or thermal pressing, may be used. Furthermore, as the adhesive, an adhesive resin used for the adhesive layer, which will be described below, may be used, although not particularly limited thereto.

<“Thermoplastic Polyimide Resin Layer/Non-Thermoplastic Polyimide Resin Layer/Adhesive Layer” Laminate>

Furthermore, as the laminate, a “thermoplastic polyimide resin layer/non-thermoplastic polyimide resin layer/adhesive layer” laminate may be used, in which using the “thermoplastic polyimide resin layer/non-thermoplastic polyimide resin layer” laminate described above, an adhesive layer is formed on a surface of the non-thermoplastic polyimide resin layer opposite to the surface provided with the thermoplastic polyimide resin layer. As the adhesive layer in the “thermoplastic polyimide resin layer/non-thermoplastic polyimide resin layer/adhesive layer” laminate, an ordinary adhesive resin can be used. A known technique can be used as long as proper resin flowability is exhibited and strong adhesiveness is achieved. The adhesive resins usable for the adhesive layer can be broadly classified into two types, i.e., thermal adhesive resins including thermoplastic resins and curable adhesive resins using curing reaction of thermosetting resins.

Examples of the thermoplastic resin which may be used as the thermally bondable adhesive resin include polyimide resins, polyamide-imide resins, polyetherimide resins, polyamide resins, polyester resins, polycarbonate resins, polyketone resins, polysulfone resins, polyphenylene ether resins, polyolefin resins, polyphenylene sulfide resins, fluorocarbon resins, polyarylate resins, and liquid crystal polymer resins. These may be used alone or in combination of two or more as the adhesive layer of the laminate. In particular, in view of excellent heat resistance, electrical reliability, etc., thermoplastic polyimide resins are preferably used. On the other hand, examples of the thermosetting resin which may be used as the thermally curable adhesive resin include bismaleimide resins, bisallylnadiimide resins, phenol resins, cyanate resins, epoxy resins, acrylic resins, methacrylic resins, triazine resins, curable hydrosilyl resins, curable allyl resins, and unsaturated polyester resins. These may be used alone or in appropriate combination. Besides the thermosetting resins described above, it is also possible to use, as thermosetting components, reactive side-chain group-containing thermosetting polymers having reactive groups, such as an epoxy group, an allyl group, a vinyl group, an alkoxysilyl group, a hydrosilyl group, or a hydroxyl group in side chains or in termini of the polymer chain. For the purpose of controlling flowability of the adhesive during thermal bonding, it is also possible to mix a thermosetting resin to the thermoplastic resin. If the amount of the thermosetting resin is excessively large, there is a possibility that the adhesive layer may become brittle. If the amount of the thermosetting resin is excessively small, there is a possibility that flowability of the adhesive may be degraded or adhesiveness may be degraded. As the adhesive used for the laminate, from the standpoints of adhesiveness, processability, heat resistance, flexibility, dimensional stability, low dielectric characteristics, costs, etc., preferably, polyimide resins, epoxy resins, and cyanate ester resins are used alone or in combination.

<Method for Allowing Organic Thiol Compound to be Carried on Surface of Polymeric Film>

A method for allowing the organic thiol compound to be carried on the surface of the polymeric film will be described below. As the method for allowing the organic thiol compound to be carried on the surface of the polymeric film, in particular, the surface of the thermoplastic polyimide resin, preferred is a method in which the organic thiol compound is allowed to be carried on the surface of the thermoplastic polyimide resin either by dipping the thermoplastic polyimide resin in a solvent in which the organic thiol compound is dissolved or by swelling and/or dissolving the thermoplastic polyimide resin using the solvent so that the surface portion of the thermoplastic polyimide resin has an appropriate thickness. The organic thiol compound strongly carried on the surface of the thermoplastic polyimide resin strongly binds with a catalyst for forming an electroless plating film on the surface of the thermoplastic polyimide resin or with the electroless plating film through the catalyst in the process of manufacturing the printed circuit board, which will be described below. As a result, it becomes possible to enhance adhesiveness between the polyimide resin composition of the present invention and the electroless plating film. Since the method for allowing the organic thiol compound to be carried on the surface of the thermoplastic polyimide resin is performed by surface treatment in the manufacturing process of the printed circuit board, details thereof will be described below.

The concentration of the organic thiol compound solution used for dipping or swelling and/or dissolving the thermoplastic polyimide resin using the solvent so that the surface portion thereof has an appropriate thickness is preferably in a range of 0.01% to 5%, and more preferably 0.1% to 1%. When a solution having a concentration that is higher than the concentration described above, the amount of the organic thiol compound carried on the surface of the polymeric film is increased, and a relatively thick layer composed of the organic thiol compound is formed. This layer may become a brittle layer, which may result in a decrease in adhesion strength between the polymeric film and the metal. When a solution having a concentration that is lower than the concentration described above is used, there is a possibility that the effect of the organic thiol compound may not be exhibited.

<Metal Layer>

A metal layer can be disposed on at least one surface of each of the polymeric film and the laminate of the present invention. Since the metal layer can be formed in the process of manufacturing the printed circuit board, details thereof will be described below under the section of the manufacturing process of the printed circuit board.

(Printed Circuit Board and Manufacturing Method of Printed Circuit Board—Embodiment I)

Printed circuit boards including polymeric films and laminates including the polyimide resin composition of the present invention (hereinafter referred to as “laminates”) and methods for manufacturing printed circuit boards will be described below. By using single layer films and laminates containing the polyimide resin composition of the present invention, printed circuit boards can be obtained. In this embodiment, as the laminates, a “thermoplastic polyimide resin layer/non-thermoplastic polyimide resin layer” laminate, a “thermoplastic polyimide resin layer/non-thermoplastic polyimide resin layer/thermoplastic polyimide resin layer” laminate, a “thermoplastic polyimide resin layer/non-thermoplastic polyimide resin layer/adhesive layer” laminate, and a “thermoplastic polyimide resin layer/non-thermoplastic polyimide resin layer/metal foil layer” laminate will be described as examples.

<Surface Treatment Process for Polyimide Resin Composition>

As described above, the polyimide resin composition of the present invention includes a thermoplastic polyimide resin and an organic thiol compound. In each of the various types of laminates, the organic thiol compound may be added to the thermoplastic polyimide resin in advance, or the organic thiol compound may be added by surface-treating the thermoplastic polyimide resin layer in the process of manufacturing a printed circuit board. In the former case, each laminate is produced using a thermoplastic polyimide resin material containing the organic thiol compound or a thermoplastic polyimide resin containing the organic thiol compound. In the latter case, by subjecting each laminate including the thermoplastic polyimide resin layer to surface treatment during the manufacturing process of the printed circuit board, the thermoplastic polyimide resin layer containing the organic thiol compound is produced.

<Process for Forming Electroless Plating Film>

In the method for manufacturing the printed circuit board of the present invention, whichever type of laminate is used, an electroless metal film formation step of forming an electroless plating film on the thermoplastic polyimide resin layer of the laminate can be applied.

Furthermore, as the electroless plating film, an electroless copper plating film; an electroless nickel plating film, or an electroless gold plating film is preferably used, and an electroless copper plating film can more preferably be used. When an electroless copper is for example used as the electroless metal, an electroless copper plating film can be formed by carrying out the steps of (1) cleaning of the surface of the thermoplastic polyimide resin layer with a cleaner/conditioner, (2) rinsing with water, (3) pre-dipping of a catalyst in an acidic solution, (4) catalyst application in an alkaline solution, (5) rinsing with water, (6) reduction, (7) rinsing with water, (8) electroless copper plating, and (9) rinsing with water in that order.

The process for forming an electroless copper plating film on the thermoplastic polyimide resin layer is not limited to the steps (1) to (9) described above, and a known process may be used. Specifically, the surface of a thermoplastic polyimide resin layer on which a catalyst has been carried by the process described above is subjected to rinsing with water, the activity of the catalyst is increased by reduction, and rinsing with water is further performed. Finally, by performing electroless copper plating, an electroless copper plating film can be formed.

The laminate in which the electroless copper plating film is formed by the process described above, adhesion strength can be increased in spite of the fact that the surface roughness Rz of the thermoplastic polyimide resin is small.

Furthermore, by using the process described above, the surface of the thermoplastic polyimide resin layer can be smoothened, and the process is suitable for forming a high-density circuit with a line/space value of 20 μm/20 μm or less. The surface roughness Rz is stipulated in the standard regarding surface profile, such as JIS B0601 or the like. For the measurement thereof, a stylus-type surface profilometer according to JIS B0651 or an optical interference-type surface profilometer according to B0652 can be used. In the present invention, the ten-point mean roughness of the surface of the thermoplastic polyimide resin layer was measured using an optical interference-type surface profilometer (NewView 5030 system manufactured by ZYGO Corporation). As described above, by using surface treatment of the present invention on the thermoplastic polyimide resin layer, the electroless plating film can be strongly bonded to a roughened surface with a lower roughness compared to the conventional case. Thus, an increase in density of a printed circuit board, i.e., formation of a fine wiring pattern, is enabled.

<Method for Allowing Organic Thiol Compound to be Carried>

Preferably, the surface treatment step for allowing the organic thiol compound to be carried on the thermoplastic polyimide resin layer is carried out between the steps (1) and (2), or simultaneously with catalyst application in the step (4). Examples of the solvent used for surface-treating the thermoplastic polyimide resin layer between the steps (1) and (2) include methanol, glycols, tetrahydrofuran, alkaline aqueous solutions, alkaline methanol solutions, amide solvents, such as N,N-dimethylformamide, N,N-dimethylacetamide, and N-methyl-2-pyrrolidone. N,N-dimethylformamide is particularly preferably used. With respect to the organic thiol compound dissolved in such a solvent, a 0.01% to 5% solution is generally used, and a 0.1% to 1% solution is preferably used. Treatment conditions, such as treating time and treating temperature, are selected from optimum conditions for allowing the organic thiol compound to be carried on the thermoplastic polyimide resin layer. Thus, the organic thiol compound can be carried on the thermoplastic polyimide resin layer. Furthermore, the thermoplastic polyimide resin layer that has been surface-treated with such a solvent is, as required, rinsed with water or methanol, and then subjected to the subsequent steps, i.e., pre-dipping of a catalyst in an acidic solution, catalyst application in an alkaline solution, rinsing with water, reduction, rinsing with water, electroless copper plating, and rinsing with water.

Furthermore, in order to allow the organic thiol compound to be carried on the thermoplastic polyimide resin layer simultaneously with the step (4) of catalyst application, for example, the following procedure is used. That is, since the catalyst application is usually performed in an alkaline aqueous solution, a sodium salt of triazine thiol that is soluble in such an alkaline aqueous solution is selected, and the sodium salt is added to the solution for the catalyst application. The suitable amount of the sodium salt of triazine thiol added is usually a concentration of about 0.01% to 1%. In the surface treatment step, by carrying out a swelling/dissolution step of swelling and/or dissolving the thermoplastic polyimide resin layer, it is possible to form a finely irregular surface with a surface roughness Rz of 1 μm or less on the surface of the thermoplastic polyimide resin layer. The swelling/dissolution step is preferable because of an effect of allowing the catalyst to be carried strongly and an effect of strengthening chemical bonding by the addition of the organic thiol.

The solution used in the liquid-phase treatment in the swelling/dissolution step is not particularly limited as long as it swells and/or dissolves the thermoplastic polyimide resin, and an aqueous solution containing an organic alkaline compound, an alkaline aqueous solution, an organic solvent, or the like is preferably used. Specific examples of the organic solvent for dissolving the thermoplastic polyimide resin include amide solvents, such as N,N-dimethylformamide, N,N-dimethylacetamide, and N-methyl-2-pyrrolidone. N,N-dimethylformamide is preferably used. Furthermore, use of a combination of an alkaline aqueous solution and an organic solvent is more preferable. Use of a combination of a sodium hydroxide aqueous solution and an ethylene glycol-based organic solvent is particularly preferable. By performing treatment using such a combination of solvents, the thermoplastic polyimide resin becomes swollen, thus being particularly effective to the object of the present invention. A mixed solution of potassium hydroxide/ethanolamine/water is also preferably used.

<Process for Forming Metal Layer by Physical Method>

Before forming an electroless plating film on a thermoplastic polyimide resin layer of each of the polymeric film and the laminate of the present invention, a metal layer may be formed by a physical method on the thermoplastic polyimide resin layer, and an electroless plating film may be formed on the metal layer formed by the physical method. In the case in which the organic thiol compound is allowed to be carried on the thermoplastic polyimide resin layer of each of the polymeric film and the laminate, this step is carried out before the metal layer is formed by the physical method.

The process for forming the metal layer by the physical method is not particularly limited. A physical method, such as vacuum vapor deposition, ion plating, or sputtering, can be used. In the present invention, the thickness of the metal layer formed by such a method is preferably 20 nm to 500 nm in view of ease of performing a semiadditive process and economics. In particular, sputtering is preferable, judging comprehensively from simplicity of the facilities, productivity, adhesiveness between the resulting conductive layer and the polymeric film, etc.

With respect to sputtering, a known method can be used. That is, DC magnetron sputtering, RF sputtering, or a modification thereof can be appropriately used according to respective needs. For example, in order to efficiently sputter a conductor, such as nickel or copper, DC magnetron sputtering is preferable. On the other hand, when sputtering is performed in a high vacuum for the purpose of preventing a sputtering gas from entering a thin film or the like, RF sputtering is suitable. DC magnetron sputtering will be described in detail below. First, a polymeric film is used as a substrate and placed in a vacuum chamber, and a vacuum is produced. Usually, by combining a rotary pump for producing a rough vacuum and a diffusion pump or a cryopump, a vacuum of 6×10-4 Pa or less is produced. Subsequently, a sputtering gas is introduced to set the pressure in the chamber at 0.1 Pa to 10 Pa, and preferably 0.1 Pa to 1 Pa, and a DC voltage is applied to a metal target to cause plasma discharge. At this stage, a magnetic field is formed on the target, and the generated plasma is confined in the magnetic field to enhance the sputtering efficiency of plasma particles to the target. While preventing the polymeric film from being influenced by the plasma and sputtering, a state of plasma generation is retained for several minutes to several hours to remove the surface oxide layer of the metal target (pre-sputtering). After the pre-sputtering is completed, sputtering is performed on the polymeric film by opening a shutter or the like. The discharge power during the sputtering is preferably in a range of 100 W to 1,000 W. Furthermore, depending on the shape of the sample subjected to sputtering, batch sputtering or roll sputtering is used. As the sputtering gas to be introduced, an inert gas, such as argon, is usually used. A mixed gas containing a small amount of oxygen, or another gas may be used.

Furthermore, in order to improve adhesion between the polyimide film and this film formed by sputtering, as pretreatment, plasma discharge, corona discharge, heat treatment, ion bombardment, or the like may the performed. Usually, if the polyimide film that has been subjected to such treatment is brought into contact with air or the like, the modified surface may be deactivated to considerably decrease the treatment effect in some cases. Therefore, preferably, such treatment is performed in a vacuum, and sputtering is continuously performed in the vacuum.

In the sputtering method described above, a uniform thin film can be formed with high accuracy. In general, in a copper or copper alloy thin film formed by sputtering, it is not possible to achieve strong adhesion to a polymeric film having high surface flatness. However, in the organic thiol compound-containing polyimide film according to the method of the present invention, it is possible to achieve adhesion strength of 5 N/cm or more. Furthermore, when the polyimide film is a thermoplastic polyimide, high adhesion strength of 7 N/cm or more is achieved.

The present inventors have further studied a method for improving adhesion and have found that an underlayer metal is preferably formed between the resin substrate and the metal film formed by sputtering in order to achieve higher adhesion. As the underlayer metal, nickel, chromium, titanium, molybdenum, tungsten, zinc, tin, indium, or an alloy thereof is used. In particular, use of nickel, chromium, or titanium is effective. Use of nickel or an alloy of nickel and chromium is particularly preferable. The main object of using the alloy of chromium and nickel is to increase the sputtering rate. In the pure metallic nickel which is a magnetic material, it is difficult to increase the sputtering rate. However, by forming an alloy of nickel and chromium, the sputtering rate can be increased. To achieve this object, the ratio of chromium to nickel is not particularly limited, but is generally, preferably 2% or more. Additionally, the thickness of such an underlayer is preferably 1 nm to 10 nm. By providing such an underlayer, in the organic thiol compound-containing polyimide film, for example, an adhesiveness of 6 N/cm or more is achieved. When the polyimide film is a thermoplastic polyimide, a high adhesion strength of 8 N/cm or more is achieved.

<Method for Manufacturing Printed Circuit Board Using “Thermoplastic Polyimide Resin Layer/Non-Thermoplastic Polyimide Resin Layer” Laminate>

Methods for manufacturing printed circuit boards using a “thermoplastic polyimide resin layer/non-thermoplastic polyimide resin layer” laminate will now be described.

(First Method for Manufacturing Printed Circuit Board)

In a first method for manufacturing a printed circuit board, first, a palladium catalyst is allowed to be carried on the surface of a thermoplastic polyimide resin layer containing an organic thiol compound, and an electroless copper plating film is formed thereon. Furthermore, a resist film is formed on the electroless copper plating film, and a portion of the resist film corresponding to a region for forming a circuit is removed by exposure and etching. Subsequently, an electrolytic copper film for forming the circuit is formed by pattern plating using electrolytic copper with the exposed portion of the electroless copper plating film being used as a feeding electrode. Subsequently, the resist film is removed and an unnecessary portion of the electroless copper plating film is removed by etching to produce the circuit. Additionally, this process is referred to as a semiadditive process.

In the first method for manufacturing the printed circuit board, after the formation of the electroless plating film, a step of heat-treating the insulating layer (thermoplastic polyimide resin layer/non-thermoplastic polyimide resin layer) and the electroless plating film may be included, this step being described in detail below under the section of manufacturing method of printed circuit board II. The step of heat-treating the insulating layer and the electroless plating film can be performed at any time as long as the wiring formation is not disturbed. For example, the heat treatment may be performed after the electroless plating film is formed, after the electrolytic copper plating film is formed on the electroless plating film, or after the layer including the electroless plating film and the electrolytic copper plating film is subjected to patterning. Although at least one heat treatment step produces a sufficient effect, the heat treatment step may be performed two or more times.

(Second Method for Manufacturing Printed Circuit Board)

A second method for manufacturing a printed circuit board is performed as follows. First, as in the first method for manufacturing the printed circuit board, a palladium catalyst is allowed to be carried on the surface of a thermoplastic polyimide resin layer containing an organic thiol compound, and an electroless copper plating film is formed thereon.

Subsequently, an electrolytic copper plating film is formed on the surface of the electroless copper plating film, and then a resist film is formed on the surface of the electrolytic copper plating film. A portion of the resist film corresponding to a region in which a circuit is not formed is removed by exposure and development, and unnecessary portions of the electrolytic copper plating film and the electroless copper plating film are removed by etching to produce the circuit.

In the second method for manufacturing the printed circuit board, it may also be possible to use a method including the step of heat-treating the insulating layer and the electroless plating film inn any step after the formation of the electroless plating film as long as the wiring formation is not disturbed.

<Method for Manufacturing Printed Circuit Board Using “Thermoplastic Polyimide Resin Layer/Non-Thermoplastic Polyimide Resin Layer/Thermoplastic Polyimide Resin Layer” Laminate>

Methods for manufacturing printed circuit boards using a “thermoplastic polyimide resin layer/non-thermoplastic polyimide resin layer/thermoplastic polyimide resin layer” laminate will now be described.

(Third Method for Manufacturing Printed Circuit Board)

In a third method for manufacturing a printed circuit board, first, a via hole is formed so as to pass through the laminate. The formation of the via hole can be performed by a hole-opening process using carbon dioxide laser, UV-YAG laser, punching, drilling, or the like. When a small via hole is formed, a hole-opening process using carbon dioxide laser or UV-YAG laser is preferably employed. After the via hole is formed, a desmearing step of removing smears mainly composed of decomposition products of the polyimide and carbides due to heat generated inside the via hole and in the periphery of the via hole. Subsequently, a catalyst application step of allowing a palladium catalyst to be carried on the surface of a thermoplastic polyimide resin layer is carried out, and an electroless copper plating film is formed on the surface of the thermoplastic polyimide resin layer and inside the via hole. Furthermore, a resist film is formed on the surface of the electroless copper plating film, and a portion of the resist film corresponding to a region for forming a circuit is removed by exposure and development. Subsequently, an electrolytic copper film for forming the circuit is formed by pattern plating using electrolytic copper with the exposed portion of the electroless copper plating film being used as a feeding electrode. Subsequently, the resist film is removed and an unnecessary portion of the electroless copper plating film is removed by etching to produce the circuit.

In the third method for manufacturing the printed circuit board, it may also be possible to use a method including the step of heat-treating the insulating layer and the electroless plating film in any step after the formation of the electroless plating film as long as the wiring formation is not disturbed.

Furthermore, when a printed circuit board is manufactured using a single layer film containing a thermoplastic polyimide resin, the third method for manufacturing the printed circuit board is used.

(Fourth Method for Manufacturing Printed Circuit Board)

A fourth method for manufacturing a printed circuit board is performed as follows. First, a via hole is formed so as to pass through the laminate. Subsequently, as in the third method for manufacturing the printed circuit board, the desmearing step and the catalyst application step are carried out, and then an electroless copper plating film is formed on the surface of the thermoplastic polyimide resin layer and inside the via hole. Subsequently, an electrolytic copper plating film is formed by pattern plating using electrolytic copper on the surface of the electroless copper plating film to electrically connect both surfaces of the laminate by the via hole. Subsequently, a resist film is formed on the surface of the electrolytic copper plating film, and a portion of the resist film corresponding to a region in which a circuit is not formed is removed by exposure and development. Subsequently, unnecessary portions of the electrolytic copper plating film and the electroless copper plating film are removed by etching to produce the circuit.

In the fourth method for manufacturing the printed circuit board, it may also be possible to use a method including the step of heat-treating the insulating layer and the electroless plating film in any step after the formation of the electroless plating film.

<Method for Manufacturing Printed Circuit Board Using “Thermoplastic Polyimide Resin Layer/Non-Thermoplastic Polyimide Resin Layer/Adhesive Layer” Laminate>

A method for manufacturing a printed circuit board using a laminate having a three-layer structure including “thermoplastic polyimide resin layer/non-thermoplastic polyimide resin layer/adhesive layer” will now be described. First, an adhesive layer of the laminate and an inner substrate having an inner circuit layer are stacked on each other, followed by curing. Subsequently, a via hole is formed by a hole-opening process using carbon dioxide laser or UV-YAG laser so that the via hole passes through the laminate and reaches the inner circuit, and then a desmearing step and a catalyst application step are carried out. Subsequently, by the same procedure as that in the third method for manufacturing the printed circuit board or the fourth method for manufacturing the printed circuit board, a circuit is produced.

Additionally, when a single layer film containing a thermoplastic polyimide resin and an inner substrate are stacked on each other to manufacture a printed circuit board, as in the method described above, the single layer film and an inner substrate having an inner circuit layer are stacked on each other, followed by curing.

<Method for Manufacturing Printed Circuit Board Using “Thermoplastic Polyimide Resin Layer/Non-Thermoplastic Polyimide Resin Layer/Metal Thin Layer” Laminate>

Methods for manufacturing printed circuit boards using a “thermoplastic polyimide resin layer/non-thermoplastic polyimide resin layer/metal thin layer” laminate will now be described.

(Fifth Method for Manufacturing Printed Circuit Board)

In a fifth method for manufacturing a printed circuit board, first, a via hole is formed so as to pass through a thermoplastic polyimide resin layer and a non-thermoplastic polyimide resin layer and to reach a metal thin layer or to pass through the metal thin layer. The formation of the via hole can be performed by a hole-opening process using carbon dioxide laser, UV-YAG laser, punching, drilling, or the like. After the via hole is formed, a desmearing step of removing smears generated on the surface of the thermoplastic polyimide resin layer and inside the via hole is carried out, and a catalyst application step of allowing a palladium catalyst to be carried on the surface of the thermoplastic polyimide resin layer is carried out. Subsequently, an electroless copper plating film is formed on the surface of the thermoplastic polyimide resin layer and inside the via hole. Then, a resist film is formed on the electroless copper plating film, and a portion of the resist film corresponding to a region for forming a circuit is removed by exposure and development. Subsequently, an electrolytic copper film for forming the circuit is formed by pattern plating using electrolytic copper with the exposed portion of the electroless copper plating film being used as a feeding electrode. Then, the resist film is removed and an unnecessary portion of the electroless copper plating film is removed by etching to produce the circuit.

In the fifth method for manufacturing the printed circuit board, it may also be possible to use a method including the step of heat-treating the insulating layer and the electroless plating film in any step after the formation of the electroless plating film.

(Sixth Method for Manufacturing Printed Circuit Board)

A sixth method for manufacturing a printed circuit board is performed as follows. First, a via hole is formed so as to pass through a thermoplastic polyimide resin layer and a non-thermoplastic polyimide resin layer and to reach a metal thin layer or to pass through the metal thin layer. A desmearing step and a catalyst application step are carried out as in the fifth method for manufacturing the printed circuit board, and then an electroless copper plating film is formed. Subsequently, an electrolytic copper plating film is formed by pattern plating using electrolytic copper on the electroless copper plating film to electrically connect both surfaces of the laminate by the via hole. Subsequently, a resist film is formed on the surface of the electrolytic copper plating film, and a portion of the resist film corresponding to a region in which a circuit is not formed is removed by exposure and development. Then, unnecessary portions of the electrolytic copper plating film and the electroless copper plating film are removed by etching to produce the circuit.

In the sixth method for manufacturing the printed circuit board, it may also be possible to use a method including the step of heat-treating the insulating layer and the electroless plating film in any step after the formation of the electroless plating film.

In order to form a thermoplastic polyimide resin layer containing an organic thiol compound, as described above, the organic thiol compound may be incorporated into the thermoplastic polyimide resin layer in advance, or the organic thiol compound may be allowed to be carried on the thermoplastic polyimide resin layer by surface treatment of the thermoplastic polyimide resin layer. As the latter surface treatment method, preferably, the thermoplastic polyimide resin layer is dipped in a solvent containing the organic thiol compound. In such a case, more preferably, the surface portion of the thermoplastic polyimide resin layer is swollen and/or dissolved. Such a surface treatment step can be included appropriately at least by the step of forming the electroless plating film in the manufacturing process of the printed circuit board. Furthermore, when the process includes a desmearing step, the surface treatment step is preferably carried out after the desmearing step. As described above, in the present invention, it is important that the organic thiol compound has been included in the thermoplastic polyimide resin layer before the step of forming the electroless plating film on the thermoplastic polyimide resin layer. Thereby, it is possible to achieve satisfactory adhesion strength between the layer composed of the polyimide resin composition of the present invention and the electroless plating film.

Furthermore, in the method for manufacturing the printed circuit board of the present invention, it is possible to appropriately select techniques and processing conditions depending on the requirements of specifications, etc. of desired printed circuit boards. It is also possible to combine other known techniques. All of these cases are included in the scope of the method for manufacturing the printed circuit board of the present invention.

That is, in the formation of the via hole, known carbon dioxide laser, UV-YAG laser, excimer laser, or the like can be used. Furthermore, in the desmearing step, a wet process using a permanganate solution, an organic alkaline solution, or the like, a dry process using plasma, or the like can be used. As the type of plating for forming the electroless plating film, chemical plating using an catalytic effect of a noble metal, such as palladium, can be used, and as the type of the metal deposited, copper, nickel, gold, or the like can be used. Furthermore, as the resist, a liquid resist, a dry film resist, or the like can be used, and in particular, a dry film resist excellent in handleability can be preferably used. Furthermore, the etchant used for removing the electroless plating film used as the feeding electrode when circuit formation is performed by a semiadditive process can be appropriately selected depending on the type of the electroless plating film. When the electroless plating film is an electroless copper plating film, a sulfuric acid/hydrogen peroxide etchant or an ammonium persulfate/sulfuric acid-based etchant is preferably used. Furthermore, when the electroless plating film is an electroless nickel plating film, an electroless gold plating film, or the like, an etchant that can selectively etch each film is used.

The methods for manufacturing printed circuit boards using various types of laminates including the polyimide resin composition of the present invention have been described above. By using any of the laminates of the present invention, ordinary manufacturing steps, such as a desmearing step or an electroless metal film formation step can be carried out. A high-density circuit with a line/space value of 20 μm/20 μm or less can be formed, and it is possible to obtain a printed circuit board having excellent adhesiveness and high reliability.

(Printed Circuit Board and Manufacturing Method of Printed Circuit Board—Embodiment II)

Methods for manufacturing printed circuit boards each capable of strongly bonding an insulating layer and an electroless plating layer according to Embodiment II of the present invention will be described below.

A method for manufacturing a printed circuit board according to the present invention includes at least a step of forming at least an electroless plating layer on an insulating layer which contains a thermoplastic resin and which has a surface roughness of less than 0.05 μm in terms of arithmetic average roughness Ra measured with a cutoff value of 0.002 mm.

Furthermore, a method for manufacturing a printed circuit board according to the present invention includes a step of forming an insulating layer on an inner circuit surface having an inner circuit layer of an inner circuit board, the insulating layer containing at least a thermoplastic resin and having a surface roughness of less than 0.05 μm in terms of arithmetic average roughness Ra measured with a cutoff value of 0.002 mm, a step of forming a via hole that passes through a region of the insulating layer on the inner circuit layer, a step of forming an electroless plating layer inside of the via hole and on the insulating layer, a step of forming a patterned electrolytic plating layer on the electroless plating layer, and a step of removing an exposed portion of the electroless plating layer.

In order to strongly bond the insulating layer having a surface roughness of less than 0.05 μm in terms of arithmetic average roughness Ra measured with a cutoff value of 0.002 mm and the electroless plating layer to each other, it is important that the manufacturing method described above further includes a step of heat-treating at least the insulating layer and the electroless plating layer after the step of forming the electroless plating layer.

In this step, the surface roughness of the insulating layer does not substantially change before and after the heat treatment, and the very low surface roughness is maintained, which is advantageous to the formation of fine lines. Furthermore, the electroless plating layer does not penetrate into the insulating layer, and thus high insulating reliability is maintained. The atmosphere during the heat treatment is not particularly limited. According to need, the heat treatment may be performed in a non-oxidizing atmosphere, such as in a vacuum atmosphere, in a low-pressure atmosphere, or in an inert gas atmosphere.

The insulating layer of the present invention has a surface roughness of less than 0.05 μm in terms of arithmetic average roughness Ra measured with a cutoff value of 0.002 mm. If this condition is satisfied, the insulating layer may be prepared from any form, such as a film or a resin solution. In the present invention, the arithmetic average roughness Ra is defined according to JIS B 0601 (revised on Feb. 1, 1994) and corresponds to a value determined by observation of the surface of the insulating layer with an optical interference-type surface-structure analyzer. In the present invention, the cutoff value means a wavelength set in determining a roughness curve from a profile curve (measured data), as described in JIS B 0601. That is, the value Ra measured with a cutoff value of 0.002 mm corresponds to the arithmetic average roughness calculated from a roughness curve obtained by removing irregularities having wavelengths longer than 0.002 mm from the measured data. Consequently, when irregularities having wavelengths shorter than 0.002 mm are not present, the value Ra measured with a cutoff value of 0.002 mm corresponds to 0 μm. Thus, the insulating layer in the present invention has a very small surface roughness and also includes, for example, an ordinary insulating film which is not particularly subjected to roughening treatment.

As described above, even in the insulating layer having a very small surface roughness, by heat-treating the insulating layer and the electroless plating layer at any stage after the step of forming the electroless plating layer on the insulating layer, it is possible to improve adhesion strength between the insulating layer and the electroless plating layer.

In each of the methods for manufacturing printed circuit boards in Embodiments 1 and 2, in the step of heat-treating the insulating layer and the electroless plating layer, preferably, the heating temperature is equal to or higher than the glass transition temperature of the insulating layer. By performing the heat treatment at the temperature equal to or higher than the glass transition temperature, the thermoplastic resin contained in the insulating layer is plasticized sufficiently to be bonded more strongly to the electroless plating layer, and thereby adhesion between the insulating layer and the electroless plating layer is significantly improved not only in the normal state but also under high-temperature, high-humidity conditions. In this step, the surface roughness of the insulating layer does not substantially change before and after the heat treatment, and the very low surface roughness is maintained, which is advantageous to the formation of fine lines. Furthermore, the electroless plating layer does not penetrate into the insulating layer, and thus high insulating reliability is maintained.

In each of the methods for manufacturing printed circuit boards, in the step of heat-treating the insulating layer and the electroless plating layer, preferably, the heating temperature is 300° C. or less. If the heating temperature is higher than 300° C., the electroless plating layer is degraded, which may result in a decrease in adhesion between the insulating layer and the electroless plating layer. The heating time is not particularly limited. In view of manufacturing efficiency, preferably, the heat treatment is performed for one minute to 120 minutes. Furthermore, as described above, the heat-treating atmosphere in the heat-treatment step is not particularly limited, and a known apparatus, such as an ordinary hot-air oven, can be used. According to need, the heat treatment may be performed in a non-oxidizing atmosphere, such as in a vacuum atmosphere, in a low-pressure atmosphere, or in an inert gas atmosphere.

Additionally, in the methods for manufacturing printed circuit boards according to Embodiment II, the same manufacturing methods described in the methods for manufacturing printed circuit boards according to Embodiment I can be employed. Furthermore, by using a resin composition containing a polyimide resin and an organic thiol compound for the insulating layer, adhesion strength between the insulating layer and the electroless plating layer can be further improved.

### EXAMPLES

While the present invention will be described in more detail based on examples and comparative examples below, it is to be understood that the present invention is not limited thereto. It will be obvious to those skilled in the art that various changes, modifications, and alterations can be made without departing from the scope of the invention.

### Embodiment I-1

### Synthesis of Thermoplastic Polyimide Resin Precursor (Production Method X)

An example of a method for producing a polyamic acid which is a precursor of a thermoplastic polyimide resin will be described below. First, 0.30 mol of 1,2-bis[2-(4-aminophenoxy)ethoxy]ethane (hereinafter referred to as “DA3EG”) and 0.70 mol of 2,2′-bis[4-(4-aminophenoxy)phenyl]propane (hereinafter referred to as “BAPP”) were dissolved in N,N-dimethylformamide (hereinafter referred to as “DMF”). While stirring the DMF solution, 0.83 mol of 3,3′,4,4′-ethylene glycol dibenzoate tetracarboxylic dianhydride (hereinafter referred to as “TMEG”) and 0.17 mol of 3,3′,4,4′-benzophenonetetracarboxylic dianhydride (hereinafter referred to as “BTDA”) were added thereto. The resulting mixture was stirred at about 25° C. for about one hour to obtain a DMF solution of a polyamic acid having a solid content of 20% by weight.

### Synthesis of Thermoplastic Polyimide Resin Precursor (Production Method Y)

Furthermore, another example of a method for producing a polyamic acid which is a precursor of a thermoplastic polyimide resin will be described below. BAPP was uniformly dissolved in DMF, and under stirring, as an acid dianhydride, 3,3′,4,4′-biphenyltetracarboxylic dianhydride and ethylenebis(trimellitic acid monoester anhydride) at a molar ratio of 4:1 were added to the solution, and a diamine was added thereto in an equimolar amount to the acid dianhydride.

Stirring was performed at about 25° C. for about one hour to obtain a DMF solution of a polyamic acid having a solid content of 20% by weight.

### Synthesis of Thermoplastic Polyimide Resin Precursor (Production method Z)

Another example of a method for producing a polyamic acid which is a precursor of a thermoplastic polyimide resin will now be described below. As a diamine, 1,3-bis(3-aminophenoxy)benzene and 3,3′-dihydroxybenzidine at a molar ratio of 4:1 were dissolved in DMF. While stirring the resulting DMF solution, as an acid dianhydride, 4,4′-(4,4′-isopropylidenediphenoxy)bis(phthalic anhydride) was added in an equimolar amount to the diamine. Stirring was performed at about 25° C. for about one hour to obtain a DMF solution of a polyamic acid having a solid content of 20% by weight.

### Organic Thiol Derivative

Organic thiol compounds used in Examples will now be described below. In Examples, as the organic thiol compound, the following reagents manufactured by Aldrich Corporation were used. As the organic monothiol compound, four types, i.e., 2-mercaptopyridine (abbreviation: MPY), 2-mercaptopyrimidine (abbreviation: MPM), 2-mercaptobenzimidazole (abbreviation: MBI), and 2-mercaptobenzothiazole (abbreviation: MBT), were used. As the organic dithiol compound, four types, i.e., 2,5-dimercapto-1,3,4-thiadiazole (abbreviation: DMT), 2,5-dimercapto-1,3,4-thiadiazole dipotassium salt (abbreviation: DMTN), 2-mercaptoethyl ether (abbreviation: DME), and 2-mercaptoethyl sulfide (abbreviation: DMES), were used. Furthermore, as the triazine thiol compound, six types, i.e., trithiocyanuric acid (abbreviation: TT), trithiocyanuric acid monosodium salt (abbreviation: TTN), 6-dibutylamino-1,3,5-triazinedithiol (abbreviation: DB), 6-dibutylamino-1,3,5-triazinedithiol monosodium salt (abbreviation: DBN), 6-anilino-1,3,5-triazinethiol (abbreviation: AF), and 6-anilino-1,3,5-triazine thiol monosodium salt (abbreviation: AFN), manufactured by Sankyo Chemical Co., Ltd., were used.

### Non-Thermoplastic Polyimide Resin Film

In Examples, as the non-thermoplastic polyimide resin film, three types of Apical films manufactured by Kaneka Corporation (AH: 25 μm thick, NPI: 25 μm thick, and HP: 25 μm thick) and other three types of non-thermoplastic polyimide resin films synthesized as described below were used.

### Non-Thermoplastic Polyimide Film—A

Into 90 g of a 17 wt % DMF (N,N-dimethylformamide) solution of a polyamic acid synthesized using pyromellitic dianhydride/4,4′-diaminodiphenyl ether/p-phenylenediamine at a molar ratio of 4/3/1, a converting agent composed of 17 g of acetic anhydride and 2 g of isoquinoline was mixed, and the resulting mixture was stirred. After defoaming by centrifugation, the mixture was applied by flow-casting onto an aluminum foil so that the resulting flow-cast solution had a thickness of 700 μm. Stirring and defoaming were performed under cooling at 0° C. The resulting laminate of the aluminum foil and the polyamic acid solution was heated at 110° C. for 4 minutes to produce a self-supporting gel film. The content of volatile components remaining in this gel film was 30 percent by weight, and the imidization ratio was 90%. This gel film was separated from the aluminum foil and fixed to a frame. This gel film was heated to 300° C., 400° C., and 500° C. for 1 minute each to produce a polyimide film with a thickness of 25 μm.

### Non-Thermoplastic Polyimide Film—B

A polyimide film was produced as in the production method-A except that synthesis was performed using pyromellitic dianhydride/4,4′-diaminodiphenyl ether at a molar ratio of 1/1.

### Non-Thermoplastic Polyimide Film—C

A polyimide film was produced as in the production method-A except that a 17 wt % DMAc (N,N-dimethylacetamide) solution of a polyamic acid synthesized using 3,3′,4,4′-biphenyltetracarboxylic dianhydride/p-phenylenebis(trimellitic acid monoester anhydride)/p-phenylenediamine/4,4′-diaminodiphenyl ether at a molar ratio of 4/5/7/2 was used.

### Production of Laminate

Methods for producing laminates in Examples will now be described below. Any of the three types of non-thermoplastic polyimide resin films described above was used as a core film, and the DMF solution of the polyamic acid as the precursor of the thermoplastic polyimide resin prepared by the production method X, Y, or Z described above was applied to both surfaces or one surface of the core film using a gravure coater.

After the application, the solvent was dried and the polyamic acid was imidized by heat treatment. At a final heating temperature of 390° C., a laminate of the thermoplastic polyimide resin layer and the non-thermoplastic polyimide resin layer was produced. Furthermore, several types of laminates including thermoplastic polyimide resin layers with different thicknesses were produced by the same method with varied amounts of the applied DMF solution of the polyamic acid. Hereinafter, for example, in the laminate in which the non-thermoplastic polyimide resin layer was AH, and the thermoplastic polyimide resin layer produced by the production method X was disposed on only one surface of AH, the laminate will be referred to as X/AH. In the laminate in which the non-thermoplastic polyimide resin layer was AH, and the thermoplastic polyimide resin layers produced by the production method X was disposed on both surfaces of AH, the laminate will be referred to as X/AH/X. In the laminate in which the non-thermoplastic polyimide resin layer was AH, the thermoplastic polyimide resin layer was disposed on one surface of AH, and a copper foil layer was disposed on the other surface of AH, the laminate will be referred to as X/AH/Cu. This applies to the other cases. With respect to X/AH/Cu, any of the three types of polyamic acids as precursors of non-thermoplastic polyimides was applied by flow-casting onto a matt surface of a rolled copper foil (BHY-22B-T, manufactured by Japan Energy Corporation) with a thickness of 18 μm, drying was performed at a final drying temperature of 500° C., and then the DMF solution of the polyamic acid as the precursor of the thermoplastic polyimide resin prepared by the production method X, Y, or Z was applied. After the application, the solvent was dried and the polyamic acid was imidized by heat treatment. By heating at a final heating temperature of 390° C., a laminate was obtained.

### Adhesive Layer

A method for forming an adhesive layer and producing a “thermoplastic polyimide resin layer/non-thermoplastic polyimide resin layer/adhesive layer” laminate will now be described below. In a nitrogen atmosphere, 1 equivalent of bis{4-(3-aminophenoxy)phenyl}sulfone (hereinafter referred to as “BAPS-M”) was dissolved in DMF. The resulting DMF solution was stirred under cooling, and 1 equivalent of 4,4′-(4,4′-isopropylidenediphenoxy)bis(phthalic anhydride) (hereinafter referred to as “BPADA”) was dissolved therein to perform polymerization. Thereby, a polyamic acid polymer solution with a solid content of 30% by weight was obtained. By heating the polyamic acid polymer solution at 200° C. under a reduced pressure of 665 Pa for 180 minutes, a solid thermoplastic polyimide resin was produced. The resulting thermoplastic polyimide resin, a novolac epoxy resin (EPIKOTE 1032H60, manufactured by Yuka Shell Co., Ltd.), and 4,4′-diaminodiphenyl sulfone (hereinafter referred to as “4,4′-DDS”) were mixed at a weight ratio of 70/30/9, and the resulting mixture was dissolved in dioxolane such that the solid content was 20% by weight. An adhesive solution was thereby obtained. The resulting adhesive solution was applied onto the non-thermoplastic polyimide resin layer of the “thermoplastic polyimide resin layer/non-thermoplastic polyimide resin layer” laminate produced above such that the thickness would be 12.5 μm after drying, and drying was performed at 170° C. for 2 minutes to form an adhesive layer. A “thermoplastic polyimide resin layer/non-thermoplastic polyimide resin layer/adhesive layer” laminate was thus obtained. Subsequently, an inner circuit board was produced using a copper-clad glass epoxy laminate provided with a copper foil and having a thickness of 12 μm. Subsequently, the laminate described above was laminated and cured on the inner circuit board by vacuum pressing under the conditions of a temperature of 200° C., a hot plate pressure of 3 MPa, a pressing time of 2 hours, and a vacuum of 1 KPa.

### Measurement of Adhesion Strength

The adhesion strength between the thermoplastic polyimide resin layer in the laminated produced by the method described above and an electroless plating film formed on the thermoplastic polyimide resin layer was measured according to IPC-TM-650-method.2.4.9 at a pattern width of 3 mm, a peel angle of 90 degrees, and a peel rate of 50 mm/min.

### Pressure Cooker Test (PCT Test)

A pressure cooker test was performed at 121° C. and 100% RH for 96 hours in order to check the environmental stability of the adhesion strength.

### Measurement of Surface Roughness

Using an optical interference-type surface profilometer (NewView 5030 system manufactured by ZYGO Corporation), Ra and Rz of the film surface were measured under the following conditions.

### Measurement Conditions

Objective lens: ×50 Mirau, image zoom: 2, FDA Res: Normal

Analysis conditions:

Remove: Cylinder, Filter: High Pass

Filter Low Waven: 0.002 mm

### Measurement of Mean Coefficient of Linear Expansion

The mean coefficient of thermal expansion was measured under the following conditions using a TMA-50 (trade name, manufactured by Shimadzu Corporation), and the mean value of the measurement at 100° C. to 200° C. was defined as the coefficient of thermal expansion of the test piece.

Measurement method: Tensile mode (load on test piece being controlled to 0 g)

Heating rate: 10° C./min

Measurement range: 30° C. to 300° C.

### Examples 1 to 18

By adding six types of triazine thiol compounds (TT, TTN, AF, AFN, DB, and DBN) to the respective DMF solutions of the polyamic acid produced by the production method X, Y, or Z described above, single layer films composed of 18 types of thermoplastic polyimide resins were produced. Subsequently, an electrolytic copper plating layer was formed on the thermoplastic polyimide resin films, and adhesion strength, etc. were measured. Description will be made in detail below. First, one of the six types of triazine thiol derivatives was added to the DMF solution of the polyamic acid produced by the production method X, Y, or Z described above in an amount of 0.1% by weight relative to the amount of the polyimide resin composition. After the addition, the DMF solution of the polyamic acid was applied onto a surface of an aluminum foil, and heat treatment was performed after separation to produce a thermoplastic polyimide resin film. The thickness of the thermoplastic polyimide resin film was set at 25 μm. For comparison, thermoplastic polyimide resin films to which the triazine thiol derivative was not added were also produced. An electroless copper plating film was formed on each of the thermoplastic polyimide resin films. Specific conditions for the formation of the electroless copper plating film are as shown in Table 1. The formation was carried out under the conditions according to the electroless copper plating process by Atotech Corporation.

Subsequently, electrolytic copper plating was performed to form an electrolytic copper plating film with a thickness of 8 μm on each electroless copper plating film, and adhesion strength at normal temperature and adhesion strength after pressure cooker test were measured. The results thereof are shown in Table 2. In each Example, an excellent adhesion strength at normal temperature of 8 N/cm or more is shown. Furthermore, an excellent adhesion strength after PCT test of 6 N/cm is shown.

TABLE 1

| | | | Treatment |
|---|---|---|---|
| Step | Composition of treating agent | | conditions |
| Cleaner/ | Cleaner Securigant 902 (*) | 40 mL/L | 60° C. |
| Conditioner | Cleaner Additive 902 (*) | 3 mL/L | 5 minute dipping |
| | Sodium hydroxide | 20 mL/L | |
| Rinsing | | | |
| with water | | | |
| Pre-dipping | Pre-dip Neogant B (*) | 20 mL/L | Room |
| | Sulfuric acid | 1 mL/L | temperature |
| | | | 1 minute dipping |
| Catalyst | Activator Neogant 834 | 40 mL/L | 40° C. |
| application | conc. (*) | | 5 minute dipping |
| | Sodium hydroxide | 4 g/L | |
| | Boric acid | 5 g/L | |
| Rinsing | | | |
| with water | | | |
| Reduction | Reducer Neogant (*) | 1 g/L | Room |
| | Sodium hydroxide | 5 g/L | temperature |
| | | | 2 minute dipping |
| Rinsing | | | |
| with water | | | |
| Electroless | Basic solution Printoganth | 80 mL/L | 35° C. |
| copper | MSK-DK (*) | | 15 minute dipping |
| | Copper solution Printoganth | 40 mL/L | |
| | MSK (*) | | |
| | Stabilizer Printoganth | 3 mL/L | |
| | MSK-DK (*) | | |
| | Reducer copper (*) | 14 mL/L | |
| Rinsing | | | |
| with water | | | |

(*) (Manufactured by Atotech Japan K.K.)

TABLE 2

| | Thermoplastic | | Adhesion | | |
|---|---|---|---|---|---|
| | polyimide/ | Adhesion | strength | | |
| | Triazine | strength | after PCT test | | |
| | thiol added | N/cm | N/cm | Ra | Rz |
| Example 1 | X/TT | 9 | 6 | 0.010 | 0.09 |
| Example 2 | X/TTN | 9 | 6 | 0.012 | 0.10 |
| Example 3 | X/AF | 8 | 6 | 0.009 | 0.09 |
| Example 4 | X/AFN | 8 | 7 | 0.009 | 0.09 |
| Example 5 | X/DB | 9 | 7 | 0.010 | 0.09 |
| Example 6 | X/DBN | 9 | 7 | 0.009 | 0.09 |
| Example 7 | Y/TT | 8 | 5 | 0.009 | 0.09 |
| Example 8 | Y/TTN | 7 | 4 | 0.011 | 0.10 |
| Example 9 | Y/AF | 7 | 4 | 0.010 | 0.10 |
| Example 10 | Y/AFN | 7 | 5 | 0.009 | 0.09 |
| Example 11 | Y/DB | 8 | 6 | 0.008 | 0.08 |
| Example 12 | Y/DBN | 9 | 6 | 0.009 | 0.10 |
| Example 13 | Z/TT | 10 | 7 | 0.009 | 0.09 |
| Example 14 | Z/TTN | 10 | 7 | 0.009 | 0.09 |
| Example 15 | Z/AF | 9 | 6 | 0.011 | 0.11 |
| Example 16 | Z/AFN | 9 | 6 | 0.010 | 0.10 |
| Example 17 | Z/DB | 11 | 7 | 0.009 | 0.09 |
| Example 18 | Z/DBN | 11 | 7 | 0.009 | 0.09 |
| Reference | X | 4 | 1 | 0.010 | 0.09 |
| Example 1 | | | | | |
| Reference | Y | 4 | 1 | 0.012 | 0.10 |
| Example 2 | | | | | |
| Reference | Z | 3 | 1 | 0.009 | 0.09 |
| Example 3 | | | | | |

### Examples 19 to 26

By adding eight types of organic thiol compounds (MPY, MPM, MBI, MBT, DMT, DMTN, DME, and DMES) to the respective DMF solutions of the polyamic acid produced the production method X, single layer films composed of eight types of thermoplastic polyimide resins were produced. Subsequently, an electrolytic copper plating film was formed on the thermoplastic polyimide resin films, and adhesion strength, etc. were measured. Description will be made in detail below. First, one of the eight types of organic thiol compounds was added to the DMF solution of the polyamic acid produced by the production method X described above in an amount of 0.1% by weight relative to the amount of the polyimide resin composition. After the addition, the DMF solution of the polyamic acid was applied onto a surface of an aluminum foil, and heat treatment was performed after separation to produce a thermoplastic polyimide resin film.

Subsequently, using the same method as that in Example 1, an electroless copper plating film and an electrolytic copper plating film were formed, and adhesion strength at normal temperature and adhesion strength after pressure cooker test were measured. The results thereof are shown in Table 3. As is evident from Table 3, in each case in which the thermoplastic polyimide resin layer to which the organic monothiol compound was added was used, the adhesion strength is 6 N/cm or more. In each case in which the thermoplastic polyimide resin layer to which the organic dithiol compound was added, the adhesion strength is 8 N/cm or more. In both cases, excellent adhesion strength is shown. The adhesion strength after PCT test is 3 N/cm or more and 5N/cm or more, respectively, and thus the effectiveness of the present invention has been confirmed.

TABLE 3

| | | | Adhesion |
|---|---|---|---|
| | Thermoplastic polyimide | Adhesion | strength after |
| | resin layer/Organic | strength | PCT test |
| | thiol compound added | (N/cm) | (N/cm) |
| Example 19 | X/MPY | 6 | 4 |
| Example 20 | X/MPM | 6 | 3 |
| Example 21 | X/MBI | 6 | 3 |
| Example 22 | X/MBT | 6 | 3 |
| Example 23 | X/DMT | 8 | 6 |
| Example 24 | X/DMTN | 9 | 6 |
| Example 25 | X/DME | 8 | 5 |
| Example 26 | X/DMES | 8 | 6 |

### Examples 27 to 38

By adding two types of triazine thiol derivatives (TT and DB) to the respective DMF solutions of the polyamic acid produced by the production method X described above, the amounts of the triazine thiol derivatives being varied, single layer films composed of 12 types of thermoplastic polyimide resins were produced. Subsequently, an electrolytic copper plating film was formed on each of the thermoplastic polyimide resin films, and adhesion strength, etc. were measured. Description will be made in detail below. First one of the two types of triazine thiol derivatives was added to the respective DMF solutions of the polyamic acid produced by the production method X described above in amounts of 0.001% by weight, 0.1% by weight, 1% by weight, 4% by weight, and 10% by weight relative to the amount of the polyimide resin composition. After the addition, the DMF solution of the polyamic acid was applied onto a surface of an aluminum foil, and heat treatment was performed after separation to produce a thermoplastic polyimide resin film for each case. The thickness of the thermoplastic polyimide resin film was set at 25 μm. Subsequently, using the same method as that in Example 1, an electroless copper plating film and an electrolytic copper plating film were formed, and adhesion strength at normal temperature and adhesion strength after pressure cooker test were measured. The results thereof are shown in Table 4. As is evident from Table 4, as the amount of addition of the triazine thiol derivative, 10% or less is appropriate. Even at an amount of addition is 0.001%, the effect of the present invention can be obtained.

TABLE 4

| | Thermoplastic polyimide | | Adhesion |
|---|---|---|---|
| | resin layer/Triazine | Adhesion | strength after |
| | thiol | strength | PCT test |
| | (amount added) | (N/cm) | (N/cm) |
| Example 27 | X/TT(0.001%) | 7 | 6 |
| Example 28 | X/TT(0.01%) | 8 | 6 |
| Example 29 | X/TT(0.1%) | 9 | 6 |
| Example 30 | X/TT(1%) | 8 | 7 |
| Example 31 | X/TT(4%) | 8 | 6 |
| Example 32 | X/TT(10%) | 6 | 4 |
| Example 33 | X/DB(0.001%) | 6 | 4 |
| Example 34 | X/DB(0.01%) | 8 | 6 |
| Example 35 | X/DB(0.1%) | 9 | 7 |
| Example 36 | X/DB(1%) | 8 | 6 |
| Example 37 | X/DB(4%) | 8 | 5 |
| Example 38 | X/DB(10%) | 5 | 4 |

### Examples 39 to 47

In each Example, instead of forming a thermoplastic polyimide resin film by adding an organic thiol compound to the DMF solution of the polyamic acid produced by the production method X, Y, or Z, a thermoplastic polyimide resin film on which an organic thiol compound was carried was formed by adding the organic thiol compound in the step of forming an electroless copper plating film on the thermoplastic polyimide resin film. Adhesion strength, etc. thereof was measured.

First, a single layer film composed of a thermoplastic polyimide resin to which an organic thiol compound was not added was formed. In the cleaner/conditioner step in the method for forming the electroless copper plating film in Example 1, one of three types of triazine thiol sodium salts (TTN, DBN, and AFN) was added to the cleaner/conditioner solution in an amount of 2 g. A thermoplastic polyimide resin film to which an organic thiol compound was not added was dipped in the cleaner/conditioner solution to perform surface treatment. Subsequently, using the same method as that in Example 1, an electroless copper plating film and an electrolytic copper plating film were formed, and adhesion strength at normal temperature and adhesion strength after pressure cooker test were measured. The results thereof are shown in Table 5. As is evident from Table 5, even in the case in which the thermoplastic polyimide resin film to which the organic thiol compound is added by the surface treatment process shown in these examples, a satisfactory effect of improving adhesiveness is obtained.

TABLE 5

| | | | Adhesion |
|---|---|---|---|
| | Thermoplastic polyimide | Adhesion | strength after |
| | resin layer/Surface | strength | PCT test |
| | treatment solution | (N/cm) | (N/cm) |
| Example 39 | X/TTN | 9 | 6 |
| Example 40 | X/DBN | 10 | 6 |
| Example 41 | X/AFN | 9 | 7 |
| Example 42 | Y/TTN | 9 | 6 |
| Example 43 | Y/DBN | 8 | 6 |
| Example 44 | Y/AFN | 7 | 5 |
| Example 45 | Z/TTN | 9 | 6 |
| Example 46 | Z/DBN | 11 | 6 |
| Example 47 | Z/AFN | 8 | 6 |

### Examples 48 to 56

In each Example, instead of forming a thermoplastic polyimide resin film by adding an organic thiol compound to the DMF solution of the polyamic acid produced by the production method X, Y, or Z, a thermoplastic polyimide resin film on which an organic thiol compound was carried was formed by adding the organic thiol compound after treatment by the cleaner/conditioner solution in the step of forming the electroless copper plating film on the thermoplastic polyimide resin film. Adhesion strength, etc. thereof was measured.

First, a thermoplastic polyimide resin film to which the organic thiol compound was not added was formed. After the cleaner/conditioner step in the method for forming the electroless copper plating film in Example 1, a 0.2% DMF solution in which one of three types of triazine thiol sodium (TT, DB, and AF) was dissolved in DMF was prepared. The thermoplastic polyimide resin film to which the organic thiol compound was not added was dipped in the DMF solution to perform surface treatment. Subsequently, using the same method as that in Example 1, an electroless copper plating film and an electrolytic copper plating film were formed, and adhesion strength at normal temperature and adhesion strength after pressure cooker test were measured. The results thereof are shown in Table 6.

TABLE 6

| | | | Adhesion |
|---|---|---|---|
| | Thermoplastic polyimide | Adhesion | strength after |
| | resin layer/Surface | strength | PCT test |
| | treatment solution | (N/cm) | (N/cm) |
| Example 48 | X/TT | 11 | 7 |
| Example 49 | X/DB | 10 | 8 |
| Example 50 | X/AF | 10 | 7 |
| Example 51 | Y/TT | 9 | 8 |
| Example 52 | Y/DB | 8 | 7 |
| Example 53 | Y/AF | 9 | 6 |
| Example 54 | Z/TT | 10 | 6 |
| Example 55 | Z/DB | 10 | 7 |
| Example 56 | Z/AF | 9 | 6 |

As is evident from Table 6, even in the case in which the thermoplastic polyimide resin film to which the organic thiol compound is added by the surface treatment process shown in these examples, a satisfactory effect of improving adhesiveness is obtained.

### Examples 57 to 60

Next, laminates each including a commercially available film and a thermoplastic polyimide resin layer were produced, and then an electrolytic copper plating film was formed on each thermoplastic polyimide resin layer. Adhesion strength, etc. thereof was measured.

As the commercially available film for producing the laminate, four commercially available films were used as typical film materials, i.e., a polyamide-imide film (Torlon, manufactured by Mitsubishi Chemical Corporation), a polyetherimide film (Ultem, manufactured by GE Corporation), a liquid crystal polymer (Vecstar, manufactured by Nippon Steel Chemical Co., Ltd.), and an aromatic polyester film (S200, manufactured by Sumitomo Chemical Co., Ltd.). The thickness of the film was set a 25 μm. A solution prepared by adding DB to the DMF solution of the polyamic acid produced by the production method Z in an amount of 0.1% by weight relative to the polyimide composition was applied onto each of the films described above to form a thermoplastic polyimide resin layer with a thickness of 4 μm. Thereby, a laminate was produced.

Using the same method as that in Example 31, an electroless copper plating film and an electrolytic copper plating film were formed on the surface of the thermoplastic polyimide resin layer of the resulting laminate. Adhesion strength at normal temperature and adhesion strength after pressure cooker test were measured. The results thereof are shown in Table 7.

TABLE 7

| | | | Adhesion |
|---|---|---|---|
| | | Adhesion | strength after |
| | | strength | PCT test |
| | Material structure | (N/cm) | (N/cm) |
| Example 57 | Z/Polyamide-imide | 10 | 7 |
| Example 58 | Z/Polyetherimide | 9 | 7 |
| Example 59 | Z/Liquid crystal | 9 | 7 |
| | polymer | | |
| Example 60 | Z/Aromatic | 8 | 6 |
| | polyester | | |

As is evident form Table 7, in each Example, the adhesion strength at normal temperature is excellent at 8 N/cm or more, and the adhesion strength after PCT test is also excellent at 6 N/cm or more.

### Examples 61 to 63

Next, laminates each including a non-thermoplastic polyimide resin layer and a thermoplastic polyimide resin layer were produced, and then an electroless copper plating film was formed on each thermoplastic polyimide resin layer. Adhesion strength, etc. thereof was measured.

As the non-thermoplastic polyimide resin layer, non-thermoplastic polyimide resin films composed of Apical AH, NPI, and HP, with a thickness of 25 μm were used. A solution prepared by adding DB to the DMF solution of the polyamic acid produced by the production method X in an amount of 0.1% by weight relative to the polyimide composition was applied onto one surface of each non-thermoplastic polyimide resin layer to form a thermoplastic polyimide resin layer with a thickness of 4 μm. Thereby, a laminate was produced. Using the same method as that in Example 31, an electroless copper plating film and an electrolytic copper plating film were formed on the surface of the thermoplastic polyimide resin layer of the resulting laminate. Adhesion strength at normal temperature and adhesion strength after pressure cooker test were measured. The results thereof are shown in Table 8.

TABLE 8

| | | | Adhesion | Coeffi- |
|---|---|---|---|---|
| | Thermoplastic | | strength | cient |
| | polyimide resin layer/ | Adhesion | after PCT | of thermal |
| | Non-thermoplastic | strength | test | expansion |
| | polyimide resin layer | (N/cm) | (N/cm) | (ppm/° C.) |
| Example 61 | X/AH | 9 | 6 | 18 |
| Example 62 | X/NPI | 10 | 7 | 16 |
| Example 63 | X/HP | 10 | 6 | 15 |

As is evident from Table 8, in each Example, the adhesion strength at normal temperature is excellent at 9 N/cm or more, and the adhesion strength after PCT test is also 6 N/cm or more. Furthermore, the mean coefficient of thermal expansion (ppm/° C., measurement range: 25° C. to 150° C.), which is an important characteristic of a circuit board, is 18 ppm/° C. or less, which is excellent.

### Example 64 to 67

Next, laminates each including thermoplastic polyimide resin layers disposed on both surfaces of the non-thermoplastic polyimide resin layer were produced, and the coefficient of thermal expansion of each laminate was measured. Furthermore, an electrolytic copper plating film was formed on each thermoplastic polyimide resin layer, and adhesion strength, etc. was measured.

First, as the non-thermoplastic polyimide resin layer, a non-thermoplastic polyimide resin film composed of NPI with a thickness of 12.5 μm was used. The DMF solution of the polyamic acid produced by the production method Y was applied onto both surfaces of the non-thermoplastic polyimide resin layer to form thermoplastic polyimide resin layers, and thereby a laminate was produced. As the laminate, four types of laminates including thermoplastic polyimide resin layers with different thicknesses, i.e., 2 μm, 4 μm, 6 μm, and 8 μm, were produced. The coefficient of thermal expansion of each laminate was measured. The results thereof are shown in Table 9. The coefficient of thermal expansion was measured after the thermoplastic polyimide resin layers were formed. In Examples, the coefficient of thermal expansion of the non-thermoplastic polyimide resin layer was 12 ppm/° C. Consequently, the coefficient of thermal expansion of the laminate was evaluated according to the following criteria:

Good (A): 20 ppm/° C. or less

Average (B): Greater than 20 ppm/° C. to 30 ppm/° C. or less

Poor (C): 30 ppm/° C. or greater

Subsequently, using the same method as that in Example 49, the thermoplastic polyimide resin layer was surface-treated with a DMF solution containing triazine thiol (DB). Then, an electroless copper plating film was formed and an electrolytic copper plating film with a thickness of 18 μm was formed. Adhesion strength at normal temperature and adhesion strength after pressure cooker test were measured. The results thereof are shown in Table 9.

TABLE 9

| | | | | Adhesion | |
|---|---|---|---|---|---|
| | Non-thermoplastic | Thermoplastic | | strength | Coefficient |
| | polyimide | polyimide | Adhesion | after | of |
| | resin layer | resin layer Y | strength | PCT test | thermal |
| | NPI (μm) | (μm) | (N/cm) | (N/cm) | expansion |
| Example 64 | 12.5 | 2 | 9 | 6 | A |
| Example 65 | 12.5 | 4 | 10 | 7 | A |
| Example 66 | 12.5 | 6 | 10 | 7 | B |
| Example 67 | 12.5 | 8 | 11 | 7 | C |

As shown in Table 9, in each Example, the adhesion strength at normal temperature is 9 N/cm or more, and adhesion strength after PCT test is 6 N/cm or more.

As is evident from the results described above, in order to obtain an excellent characteristic (low thermal expansion) of the non-thermoplastic polyimide resin layer, the total thickness of the thermoplastic polyimide resin layers formed on both surfaces of the non-thermoplastic polyimide resin layer is preferably a half or less of the thickness of the non-thermoplastic polyimide resin layer, and more preferably one third or less.

### Example 68

Next, a laminate having a structure of Y/HP/Y (Y: 4 μm thick, HP: 25 μm thick) was formed, and using the laminate, a circuit was produced by a method described below.

First, using UV-YAG laser, a via hole with an inner diameter of 30 μm was formed so as to pass through the laminate. Smears were removed from the via hole by desmearing treatment using permanganate. The desmearing treatment was performed using a permanganate desmearing system manufactured by Atotech Corporation shown in Table 10.

TABLE 10

| | | | Treatment |
|---|---|---|---|
| Step | Composition of treating agent | | conditions |
| Swelling | Swelling Securigant P (*) | 500 mL/L | 60° C. |
| | NaOH | 3 g/L | 5 minute dipping |
| (Rinsing | | | |
| with water) | | | |
| Microetching | Concentrate Compact CP | 550 mL/L | 80° C. |
| | (*) | | |
| | NaOH | 40 g/L | 5 minute dipping |
| (Rinsing | | | |
| with water) | | | |
| Reduction | Reduction solution | 70 mL/L | 40° C. |
| | Securigant P500 (*) | | 5 minute dipping |
| | Sulfuric acid | 50 mL/L | |
| (Rinsing | | | |
| with water) | | | |

(*) (Manufactured by Atotech Japan K.K.)

Subsequently, using the same surface treatment method as that in Example 49, the thermoplastic polyimide resin layer was surface-treated with triazine thiol (DB). Then, an electroless copper plating film was formed on the surface of the thermoplastic polyimide resin layer and inside the via hole. Subsequently, the surface of the thermoplastic polyimide resin layer and the inside of the via hole were coated with a liquid photosensitive plating resist (THB320P manufactured by Japan Synthetic Rubber Company), and then mask exposure was performed using a high-voltage mercury-arc lamp to produce a resist pattern with a line/space value of 15 μm/15 μm. Subsequently, by forming an electrolytic copper plating film with a thickness of 10 μm, a copper circuit was formed on the surface of the exposed portion of the electroless copper plating film. In order to form the electrolytic copper plating film, preliminary rinsing was performed in 10% sulfuric acid for 30 seconds and then plating was performed for 40 minutes at room temperature. The current density was 2 A/dm². Subsequently, using an alkaline resist stripper, the liquid photosensitive plating resist was removed, and the electroless copper plating film was removed using a sulfuric acid/hydrogen peroxide-based etchant to obtain a printed circuit board. The resulting printed circuit board had a line/space value as designed. Furthermore, the circuit pattern was strongly bonded at a strength of 9 N/cm.

### Example 69

Next, a laminate having a structure of X/HP/Cu (X: 1 μm thick, HP: 25 μm thick, copper foil layer: 15 μm thick) was produced, and using the laminate, a circuit was produced by a method described below.

Using UV laser, a via hole was formed from the thermoplastic polyimide resin layer side so as to pass through thermoplastic polyimide resin layer and the non-thermoplastic polyimide resin layer to reach the copper foil layer. Subsequently, smears were removed from the via hole by desmearing treatment using permanganate. Using the same surface treatment method as that in Example 48, the thermoplastic polyimide resin layer and the via hole were surface-treated with triazine thiol (TT). Then, an electroless copper plating film and an electrolytic copper plating film were formed on the surface of the thermoplastic polyimide resin layer and inside the via hole. A dry film resist (Asahi Kasei dry resist AQ) was applied onto the electrolytic copper plating film and the copper foil layer (copper layers on both surfaces), and exposure and development were performed. Then, by using an ordinary subtractive process, a printed circuit board was produced in which a circuit with a line/space of 20 μm/20 μm was formed on the thermoplastic polyimide resin layer side surface and a circuit with a line/space of 100 μm/100 μm was formed on the copper foil layer side surface. As the etchant, a ferric chloride aqueous solution was used. The resulting printed circuit board had a line/space value as designed and the circuit pattern was strongly bonded at a strength of 9 N/cm.

### Example 70

Next, a laminate having a “thermoplastic polyimide resin layer/non-thermoplastic polyimide resin layer/adhesive layer” structure was produced, and using the laminate, a circuit was produced by a method described below.

First, the DMF solution of the polyamic acid produced by the production method Y described above was applied onto one surface of a non-thermoplastic polyimide resin layer composed of HP having a thickness of 12.5 μm to form a thermoplastic polyimide resin layer, and thereby a “thermoplastic polyimide resin layer/non-thermoplastic polyimide resin layer” laminate was produced. The thickness of the thermoplastic polyimide resin layer was 3 μm. Subsequently, by applying an adhesive layer (12 μm) onto a surface of the non-thermoplastic polyimide resin layer not provided with the thermoplastic polyimide resin layer, a “thermoplastic polyimide layer/non-thermoplastic polyimide layer/adhesive layer” laminate was produced.

Using the method described above, the resulting laminate was laminated by curing on an inner circuit board produced from a copper-clad glass epoxy laminate.

Subsequently, using UV-YAG laser, a via hole with an inner diameter of 30 μm was formed so as to reach the inner circuit, and smears were removed from the via hole by desmearing treatment using permanganate. Subsequently, by the same surface treatment method as that in Example 40, the surface of the thermoplastic polyimide resin layer and the inside of the via hole were surface-treat with triazinethiol (TT). Then, an electroless copper plating film was formed on the surface of the thermoplastic polyimide resin layer and inside the via hole. Subsequently, the surface of the thermoplastic polyimide resin layer and the inside of the via hole were coated with a liquid photosensitive plating resist (THB320P manufactured by Japan Synthetic Rubber Company), and then mask exposure was performed using a high-voltage mercury-arc lamp to produce a resist pattern with a line/space value of 15 μm/15 μm. Subsequently, by forming an electrolytic copper plating film with a thickness of 10 μm, a copper circuit was formed on the surface of the exposed portion of the electroless copper plating film. In order to form the electrolytic copper plating film, preliminary rinsing was performed in 10% sulfuric acid for 30 seconds and then plating was performed for 40 minutes at room temperature. The current density was 2 A/dm². Subsequently, using an alkaline resist stripper, the liquid photosensitive plating resist was removed, and the electroless copper plating film was removed using a sulfuric acid/hydrogen peroxide-based etchant to obtain a printed circuit board. The resulting printed circuit board had a line/space value as designed. Furthermore, the circuit pattern was strongly bonded at strength of 10 N/cm.

### Embodiment I-2

In Examples below, a metal layer formed by a physical method was formed before the formation of an electroless plating layer on a single layer film or a laminate. The metal layer was formed by the following physical method.

### Metal Layer Formed by Physical Method

The formation of a metal layer on the polyimide film produced by the method described above was performed using a sputtering system NSP-6 manufactured by Showa Shinku Co., Ltd. according to a method described below.

A polymeric film was fixed on a jig, and a vacuum chamber was closed. A vacuum of 6×10⁻⁴ Pa or less was produced while applying heat by a lamp heater and while rotating and revolving the substrate (polymeric film). Subsequently, an argon gas was introduced into the chamber to set a pressure at 0.35 Pa, nickel was sputtered, and then copper was sputtered by DC sputtering. Both were sputtered with a DC power of 200 W. The deposition rate was 7 nm/min for nickel and 11 nm/min for copper. By adjusting the deposition time, the film thickness was controlled.

### Examples 71 to 88

Six types of triazine thiol derivatives (TT, TTN, AF, AFN, DB, and DBN) was added to the respective DMF solutions of the polyamic acid produced by the production method A, B, or C in an amount of 0.1% by weight relative to the amount of the polyimide resin. After the addition, each solution was applied onto a surface of an aluminum foil, and separation and heat treatment were performed. Polyimide films were thereby formed. The thickness of each polyimide film was 25 μm. For comparison, polyimide films to which the triazine thiol was not added were also produced. A metal layer including a Ni underlayer (5 nm) and a Cu layer (200 nm) was formed by sputtering on each of these samples.

Then, electroless plating was performed under the following Subsequently a copper layer with a thickness of 8 μm was formed by electrolytic copper plating, and adhesion strength at normal temperature and adhesion strength after pressure cooker test were measured. The results thereof are shown in Table 11.

TABLE 11

| | | | Adhesion |
|---|---|---|---|
| | Non-thermoplastic | Adhesion | strength after |
| | polyimide/ | strength | PCT test |
| | Triazine thiol added | (N/cm) | (N/cm) |
| Example 71 | A/TT | 7 | 3 |
| Example 72 | A/TTN | 6 | 4 |
| Example 73 | A/AF | 7 | 4 |
| Example 74 | A/AFN | 6 | 3 |
| Example 75 | A/DB | 7 | 4 |
| Example 76 | A/DBN | 7 | 3 |
| Example 77 | B/TT | 6 | 3 |
| Example 78 | B/TTN | 6 | 4 |
| Example 79 | B/AF | 6 | 4 |
| Example 80 | B/AFN | 6 | 5 |
| Example 81 | B/DB | 7 | 4 |
| Example 82 | B/DBN | 8 | 4 |
| Example 83 | C/TT | 7 | 5 |
| Example 84 | C/TTN | 7 | 5 |
| Example 85 | C/AF | 6 | 4 |
| Example 86 | C/AFN | 6 | 4 |
| Example 87 | C/DB | 6 | 5 |
| Example 88 | C/DBN | 7 | 4 |
| Comparative | A | 4 | 1 |
| Example 1 | | | |
| Comparative | B | 4 | 1 |
| Example 2 | | | |
| Comparative | C | 3 | 1 |
| Example 3 | | | |

In each Example, the adhesion strength at normal strength after PCT test is also excellent at 4 N/cm. In contrast, in the systems to which the triazine thiol derivative was not added (Comparative Examples 1 to 3), the adhesion strength is 4 N/cm or less. Thus, the effectiveness of the present invention has been confirmed.

### Examples 89 to 106

Six types of triazine thiol derivatives (TT, TTN, AF, AFN, DB, and DBN) was added to the respective DMF solutions of the polyamic acid produced by the production method X, Y, or Z in an amount of 0.1% by weight relative to the amount of the polyimide resin. After the addition, each solution was applied onto a surface of an aluminum foil, and separation and heat treatment were performed. Thermoplastic films were thereby formed. The thickness of each thermoplastic polyimide film was 25 μm. A metal layer including a Ni underlayer (5 nm) and a Cu layer (200 nm) was formed by sputtering on each of these samples. For comparison, thermoplastic polyimide films to which the triazine thiol was not added were also produced. These samples were subjected to electroless plating under the conditions described above. Subsequently a copper layer with a thickness of 8 μm was formed by electrolytic copper plating, and adhesion strength at normal temperature and adhesion strength after pressure cooker test were measured. The results thereof are shown in Table 12. In each Example, the adhesion strength at normal temperature is excellent at 9 N/cm or more, and the adhesion strength after PCT test is also excellent at 6 N/cm. In contrast, in the systems to which the triazine thiol derivative was not added (Comparative Examples 4 to 6), the adhesion strength is 5 N/cm or less. Thus, the effectiveness of the present invention has been confirmed.

TABLE 12

| | | | Adhesion |
|---|---|---|---|
| | | Adhesion | strength after |
| | Thermoplastic polyimide/ | strength | PCT test |
| | Triazine thiol added | (N/cm) | (N/cm) |
| Example 89 | X/TT | 11 | 7 |
| Example 90 | X/TTN | 10 | 6 |
| Example 91 | X/AF | 8 | 5 |
| Example 92 | X/AFN | 11 | 6 |
| Example 93 | X/DB | 11 | 7 |
| Example 94 | X/DBN | 10 | 6 |
| Example 95 | Y/TT | 10 | 6 |
| Example 96 | Y/TTN | 11 | 5 |
| Example 97 | Y/AF | 10 | 7 |
| Example 98 | Y/AFN | 10 | 5 |
| Example 99 | Y/DB | 9 | 5 |
| Example 100 | Y/DBN | 12 | 6 |
| Example 101 | Z/TT | 9 | 6 |
| Example 102 | Z/TTN | 10 | 7 |
| Example 103 | Z/AF | 8 | 5 |
| Example 104 | Z/AFN | 8 | 6 |
| Example 105 | Z/DB | 8 | 5 |
| Example 106 | Z/DBN | 10 | 6 |
| Reference | X | 5 | 1 |
| Example 4 | | | |
| Reference | Y | 6 | 1 |
| Example 5 | | | |
| Reference | Z | 4 | 1 |
| Example 6 | | | |

### Examples 107 to 114

Eight types of organic thiol compounds (MPY, MPM, MBI, MBT, DMT, DMTN, DME, and DMES) was added to the respective DMF solutions of the polyamic acid produced by the production method X in an amount of 0.1% by weight relative to the amount of the polyimide resin. After the addition, each solution was applied onto a surface of an aluminum foil, and separation and heat treatment were performed. Thermoplastic films were thereby formed. Subsequently, as in Example 71, layers were formed by sputtering, and an electroless copper plating film and an electrolytic copper plating film were formed. Adhesion strength thereof was measured. The results thereof are shown in Table 13. With respect to each thiol derivative, the adhesion strength is excellent at 7 N/cm or more, and with respect to each dithiol derivative, the adhesion strength is excellent at 9 N/cm or more. The adhesion strengths after PCT test are, respectively, 4 N/cm and 5 N/cm or more. Thus, the effectiveness of the present invention has been confirmed.

TABLE 13

| | | | Adhesion |
|---|---|---|---|
| | Thermoplastic | | strength |
| | polyimide/ | Adhesion | after PCT |
| | Thiol | strength | test |
| | derivative added | (N/cm) | (N/cm) |
| Example 107 | X/MPY | 7 | 4 |
| Example 108 | X/MPM | 8 | 5 |
| Example 109 | X/MBI | 7 | 4 |
| Example 110 | X/MBT | 7 | 5 |
| Example 111 | X/DMT | 11 | 7 |
| Example 112 | X/DMTN | 9 | 6 |
| Example 113 | X/DME | 10 | 7 |
| Example 114 | X/DMES | 10 | 6 |

### Examples 115 to 126

Two types of triazine thiol derivatives (TT and DB) was added to the respective DMF solutions of the polyamic acid produced by the production method X, the amounts of the triazine thiol derivatives being varied. After the addition, each solution was applied onto a surface of an aluminum foil, and separation and heat treatment were performed. Thermoplastic films were thereby formed. The thickness of each thermoplastic polyimide film was 25 μm.

Subsequently, as in Example 71, layers were formed by sputtering, and an electroless copper plating film and an electrolytic copper plating film were formed. Adhesion strength at normal temperature and adhesion strength after pressure cooker test were measured. The results thereof are shown in Table 14. As is evident from the results, as the amount of addition, 10% or less is appropriate. Even at an amount of addition of 0.001%, the effect of the present invention can be obtained.

TABLE 14

| | | | Adhesion |
|---|---|---|---|
| | Non-thermoplastic | | strength |
| | polyimide/ | Adhesion | after PCT |
| | Triazine thiol | strength | test |
| | (amount added) | (N/cm) | (N/cm) |
| Example 115 | X/TT(0.001%) | 8 | 7 |
| Example 116 | X/TT(0.01%) | 9 | 6 |
| Example 117 | X/TT(0.1%) | 11 | 7 |
| Example 118 | X/TT(1%) | 11 | 7 |
| Example 119 | X/TT(4%) | 9 | 6 |
| Example 120 | X/TT(10%) | 6 | 5 |
| Example 121 | X/DB(0.001%) | 8 | 5 |
| Example 122 | X/DB(0.01%) | 10 | 7 |
| Example 123 | X/DB(0.1%) | 11 | 7 |
| Example 124 | X/DB(1%) | 11 | 7 |
| Example 125 | X/DB(4%) | 9 | 6 |
| Example 126 | X/DB(10%) | 6 | 5 |

### Example 127 to 135

A thermoplastic polyimide resin film produced by the production method X, Y, or Z was dipped in a solution prepared by adding 2 g of a triazine thiol sodium salt (TTN, DBN, or AFN) to a cleaner/conditioner solution (the same one as that used in the electroless plating process in Example 1) to perform surface treatment. Subsequently, as in Example 71, layers were formed by sputtering, and an electroless copper plating film and an electrolytic copper plating film were formed. Adhesion strength thereof was measured. The results thereof are shown in Table 15. As is evident from the results, in the surface treatment shown in these examples, a satisfactory effect of improving adhesiveness is obtained.

TABLE 15

| | | | Adhesion |
|---|---|---|---|
| | | | strength |
| | Polyimide/ | Adhesion | after PCT |
| | Surface treatment | strength | test |
| | solution | (N/cm) | (N/cm) |
| Example 127 | X/TTN | 9 | 6 |
| Example 128 | X/DBN | 10 | 6 |
| Example 129 | X/AFN | 11 | 7 |
| Example 130 | Y/TTN | 10 | 7 |
| Example 131 | Y/DBN | 9 | 6 |
| Example 132 | Y/AFN | 10 | 7 |
| Example 133 | Z/TTN | 9 | 7 |
| Example 134 | Z/DBN | 11 | 7 |
| Example 135 | Z/AFN | 8 | 6 |

### Examples 136 to 144

A thermoplastic polyimide resin film produced by the production method X, Y, or Z was dipped in a 0.2% DMF solution of triazine thiol sodium (TT, DB, or AF) to perform surface treatment. Subsequently, as in Example 71, layers were formed by sputtering, and an electroless copper plating film and an electrolytic copper plating film were formed. Adhesion strength thereof was measured. The results thereof are shown in Table 16. As is evident from the results, in the surface treatment shown in these examples, a satisfactory effect of improving adhesiveness is obtained.

TABLE 16

| | | | Adhesion |
|---|---|---|---|
| | Polyimide/ | Adhesion | strength after |
| | Surface treatment | strength | PCT test |
| | solution | (N/cm) | (N/cm) |
| Example 136 | X/TT | 9 | 7 |
| Example 137 | X/DB | 10 | 8 |
| Example 138 | X/AF | 9 | 6 |
| Example 139 | Y/TT | 9 | 6 |
| Example 140 | Y/DB | 11 | 7 |
| Example 141 | Y/AF | 10 | 7 |
| Example 142 | Z/TT | 11 | 8 |
| Example 143 | Z/DB | 9 | 7 |
| Example 144 | Z/AF | 9 | 7 |

### Examples 145 to 148

Four commercially available films were used as typical core film materials, i.e., a polyamide-imide film (Torlon, manufactured by Mitsubishi Chemical Corporation), a polyetherimide film (Ultem, manufactured by GE Corporation), a liquid crystal polymer (Vecstar, manufactured by Nippon Steel Chemical Co., Ltd.), and an aromatic polyester film (S200, manufactured by Sumitomo Chemical Co., Ltd.). (The thickness of each film was 25 μm.) A solution prepared by adding DB to the polyamic acid solution produced by the production method Z in an amount of 1% by weight relative to the polyimide composition was applied onto each of the films described above to form a thermoplastic polyimide resin layer with a thickness of 4 μm. Thereby, a laminate was produced.

With respect to each sample of the thermoplastic polyimide film Z thus obtained, as in Example 71, layers were formed by sputtering, and an electroless copper plating film and an electrolytic copper plating film were formed. Adhesion strength thereof was measured. The results thereof are shown in Table 17. In each Example, the adhesion strength at normal temperature is excellent at 9 N/cm or more, and the adhesion strength after PCT test is also excellent at 6 N/cm.

TABLE 17

| | | | Adhesion |
|---|---|---|---|
| | | Adhesion | strength after |
| | | strength | PCT test |
| | Material Structure | (N/cm) | (N/cm) |
| Example 145 | Z/Polyamide-imide | 10 | 6 |
| Example 146 | Z/Polyetherimide | 11 | 7 |
| Example 147 | Z/Liquid crystal | 10 | 8 |
| | polymer | | |
| Comparative | Z/Aromatic polyester | 9 | 6 |
| Example 148 | | | |

### Examples 149 to 151

Each sample was prepared using a non-thermoplastic polyimide film manufactured by Kaneka Corporation (Apical AH, NPI, or HP (25 μm thick)) and applying the thermoplastic resin X (composition prepared by adding DB to the polyimide composition in an amount of 1% by weight) onto one surface of the non-thermoplastic polyimide film (coating thickness: 4 μm). Using the sample, as in Example 71, electroless plating and electrolytic plating were performed. The results thereof are shown in Table 18.

TABLE 18

| | | | Adhesion | |
|---|---|---|---|---|
| | Thermoplastic | | strength | Coefficient |
| | polyimide film/ | Adhesion | after PCT | of thermal |
| | Non-thermoplastic | strength | test | expansion |
| | polyimide film | (N/cm) | (N/cm) | (ppm/° C.) |
| Example 149 | X/AH | 11 | 7 | 18 |
| Example 150 | X/NPI | 10 | 7 | 16 |
| Example 151 | X/HP | 11 | 6 | 15 |

In each Example, the adhesion strength is excellent at 10 N/cm or more. Furthermore, the mean coefficient of linear thermal expansion (ppm/° C., measurement range: 25° C. to 150° C.), which is an important characteristic of a circuit board, is 18 ppm/° C. or less, which is excellent.

### Example 152

A laminate having a structure of Y/HP/Y (Y: 4 μm thick, HP: 25 μm thick) was produced, and as in Example 136, the thermoplastic polyimide resin was subjected to surface treatment with triazine thiol (DB), and subsequently, layers were formed by sputtering. Using the laminate, a circuit was produced by a method described below.

First, using UV-YAG laser, a via hole with an inner diameter of 30 μm was formed so as to pass through the laminate. Smears were removed from the via hole by desmearing treatment using permanganate. The desmearing treatment was performed using a permanganate desmearing system manufactured by Atotech Corporation shown in Table 10.

Then, a copper plating layer was formed inside the via hole by electroless plating. Subsequently, coating was performed with a liquid photosensitive plating resist (THB320P manufactured by Japan Synthetic Rubber Company), and then mask exposure was performed using a high-voltage mercury-arc lamp to produce a resist pattern with a line/space value of 15/15. Subsequently, by performing electrolytic copper plating, a copper circuit was formed on the surface of the exposed portion of the electroless copper plating film. In the electrolytic copper plating process, preliminary rinsing was performed in 10% sulfuric acid for 30 seconds and then plating was performed for 40 minutes at room temperature. The current density was 2 A/dm². Then, the plating resist was removed using an alkaline resist stripper, and the electroless copper plating layer was removed using a sulfuric acid/hydrogen peroxide-based etchant to obtain a printed circuit board.

The resulting printed circuit board had a line/space value as designed. Furthermore, the circuit pattern was strongly bonded at a strength of 9 N/cm.

### Example 153

First, a laminate having a structure of X/HP/Cu (X: 1 μm, AH: 25 μm, copper foil: 15 μm) was prepared. As in Example 66, X was subjected to surface treatment with triazine thiol (TT), and a layer was formed by sputtering on X.

Using the laminate, a circuit was produced by a method described below.

Using UV laser, a via hole was formed from the thermoplastic polyimide resin layer side so as to pass through thermoplastic polyimide resin layer and the non-thermoplastic polyimide resin layer to reach the copper foil layer. Subsequently, smears were removed from the via hole by desmearing treatment using permanganate. Furthermore, electroless copper plating and electrolytic copper plating were performed. Subsequently, a dry film resist (Asahi Kasei dry resist AQ) was applied onto both surfaces of the copper layers, and exposure and development were performed. By using an ordinary subtractive process, a circuit with a L/S of 20/20 μm was produced on the thermoplastic polyimide surface side, and a circuit with 100/100 μm was produced on the copper foil side. As the etchant, a ferric chloride aqueous solution was used.

The resulting printed circuit board had a line/space value as designed and the circuit pattern was strongly bonded at a strength of 10 N/cm.

### Example 154

A laminate was produced by a method in which the polyamic acid solution produced by the production method Y was applied onto one surface of the non-thermoplastic polyimide film HP produced by the polyimide film production method C having a thickness of 12.5 μm. The thickness of the thermoplastic polyimide film was 3 μm. Subsequently, an adhesive layer (12 μm) was applied onto the non-thermoplastic polyimide film, and thereby a “thermoplastic polyimide layer/non-thermoplastic polyimide layer/adhesive layer” laminate was obtained. The resulting laminate was laminated by curing on an inner circuit board produced from a copper-clad glass epoxy laminate. The lamination process was the same as that described above. Then, as in Example 66, the surface of the thermoplastic polyimide resin was surface-treated with triazine thiol (TT), and a layer was formed by sputtering on the surface by a conventional method.

Subsequently, using UV-YAG laser, a via hole with an inner diameter of 30 μm was formed so as to reach the inner circuit, and smears were removed from the via hole by desmearing treatment using permanganate. Then, an electroless copper plating layer was formed by electroless plating inside the via hole. Subsequently, coating was performed with a liquid photosensitive plating resist (THB320P manufactured by Japan Synthetic Rubber Company), and then mask exposure was performed using a high-voltage mercury-arc lamp to produce a resist pattern with a line/space value of 15/15. Subsequently, by performing electrolytic copper plating, a copper circuit was formed on the surface of the exposed portion of the electroless copper plating film. In the electrolytic copper plating process, preliminary rinsing was performed in 10% sulfuric acid for 30 seconds and then plating was performed for 40 minutes at room temperature. The current density was 2 A/dm². Then, using an alkaline resist stripper, the plating resist was removed, and the electroless copper plating layer was removed using a sulfuric acid/hydrogen peroxide-based etchant to obtain a printed circuit board.

The resulting printed circuit board had a line/space value as designed. Furthermore, the circuit pattern was strongly bonded at a strength of 10 N/cm.

### Embodiment-II

### Formation of Non-Thermoplastic Polyimide Film

A non-thermoplastic polyimide film C was produced by the same method as that for the non-thermoplastic polyimide film C used in Embodiment I.

### Production Method 1 of Thermoplastic Polyimide Precursor

1,3-Bis(3-aminophenoxy)benzene was dissolved in DMF. While stirring the resulting DMF solution, 4,4′-(4,4′-isopropylidenediphenoxy)bis(phthalic anhydride) was added thereto such that the diamine and the acid dianhydride were equimolar. Stirring was performed at 25° C. for about one hour to obtain a DMF solution (b) of a polyamic acid having a solid content of 20% by mass.

### Production Method 2 of Thermoplastic Polyimide Precursor

1,3-Bis(3-aminophenoxy)benzene and 3,3′-dihydroxybenzidine at a molar ratio of 95:5 were dissolved in DMF. While stirring the resulting DMF solution, 4,4′-(4,4′-isopropylidenediphenoxy)bis(phthalic anhydride) was added thereto such that the diamine and the acid dianhydride were equimolar. Stirring was performed at 25° C. for about one hour to obtain a DMF solution (c) of a polyamic acid having a solid content of 20% by mass.

### Production Method 1 of Thermoplastic Polyimide

The DMF solution of the polyamic acid (b) was transferred to a vat coated with Teflon® and heated in a vacuum oven at 200° C. for 180 minutes under a reduced pressure of 665 Pa to produce a thermoplastic polyimide resin (d).

### Production Method 2 of Thermoplastic Polyimide

The DMF solution (c) of the polyamic acid was transferred to a vat coated with Teflon® and heated in a vacuum oven at 200° C. for 180 minutes under a reduced pressure of 665 Pa to produce a thermoplastic polyimide resin (e).

### Production Method 1 of Thermoplastic Polyimide Resin Solution

The thermoplastic polyimide resin (d) was added to and dissolved in dioxolane by stirring to produce a resin solution (f) (solid content (SC)=20%).

### Production Method 2 of Thermoplastic Polyimide Resin Solution

The thermoplastic polyimide resin (e) was added to and dissolved in dioxolane by stirring to produce a resin solution (g) (solid content (SC)=20%).

### Production Method of Thermoplastic Polyimide Resin Composition Solution

The thermoplastic polyimide resin (e), an epoxy resin (N660, manufactured by Dainippon Ink and Chemicals, Inc.), a phenol resin (NC30, manufactured by Gunei Chemical Industry Co., Ltd.), and 2-ethyl-4-methylimidazole (2E4MZ, manufactured by Shikoku Chemicals Corporation) serving as a curing accelerator were measured to satisfy a mass ratio of 50:31.1:18.9:0.06 and added to and dissolved in dioxolane by stirring to produce a resin composition solution (h) (solid content (SC)=20%). Herein, the term “thermoplastic polyimide resin composition” means a composition including a thermoplastic polyimide resin and a resin or resins other than the thermoplastic polyimide resin.

### Production of Laminate—1

The non-thermoplastic polyimide film C was used as a core film, and the DMF solution (c) of the polyamic acid was applied onto one surface thereof using a gravure coater. After the application, the solvent was dried and the polyamic acid was imidized by heat treatment. At a final heating temperature of 300° C., a laminated polyimide film (i) including a non-thermoplastic polyimide resin layer and a thermoplastic polyimide resin layer was produced. The amount of application was adjusted so that the thickness of the thermoplastic polyimide resin layer was 4 μm after drying and imidization.

### Production of laminate—2

The non-thermoplastic polyimide film C was used as a core film, and the resin composition solution (h) was applied onto one surface thereof using a gravure coater. After the application, the solvent was dried and curing reaction was carried out by heat treatment. At a final heating temperature of 200° C., a laminated polyimide film (j) including the non-thermoplastic polyimide resin layer and the polyimide resin composition layer was produced. The amount of application was adjusted so that the thickness of the thermoplastic polyimide/curing component layer was 4 μm after drying.

### Production of laminate—3

The resin composition solution (h) was applied onto a surface of the laminated polyimide film (j) opposite to the surface provided with the polyimide resin composition layer using a gravure coater. After the application, the solvent was dried by heat treatment. At a final drying temperature of 140° C., a laminated polyimide film (k) having a polyimide resin composition layer/non-thermoplastic polyimide resin layer/semi-cured polyimide resin composition layer (adhesive layer) structure was produced. The amount of application was adjusted so that the thickness of the polyimide resin composition layer in the semi-cured state was 25 μm.

### Electroless Plating Process

The same electroless plating process as that described in Embodiment I was used.

### Electrolytic Copper Plating Process

With respect to electrolytic copper plating, preliminary rinsing was performed in 10% sulfuric acid for 30 seconds and then electrolytic copper plating was performed for 40 minutes at room temperature. The current density was 2 A/dm². The thickness of the electrolytic copper plating layer was about 18 μm.

### Resist Film Formation Process

With respect to a plating resist film, liquid photosensitive plating resist (THB320P manufactured by Japan Synthetic Rubber Company) coating was performed, and then mask exposure was performed using a high-voltage mercury-arc lamp to produce a resist pattern with a desired L/S.

### Measurement of Glass Transition Temperature (Tg)

The storage modulus (ε′) of each of various types of films used as an insulating layer was measured by the following method and the temperature at the inflection point of the measured storage modulus was defined as the glass transition temperature of the film. The storage modulus (ε′) was measured with respect to a film sample having a width of 9 mm and a length of 40 mm using DMS0200 (manufactured by Seiko Electronics Industry Co., Ltd.) with a measurement length (distance between fixtures) of 20 mm in a dry air atmosphere, at a heating rate of 3° C./min, at 20° C. to 400° C.

### Measurement of Surface Roughness

Using an optical interference-type surface profilometer (NewView 5030 system manufactured by ZYGO Corporation), the arithmetic average roughness of the resin surface was measured under the following conditions.

### Measurement Conditions

Objective lens: ×50 Mirau, image zoom: 2

FDA Res: Normal

Analysis conditions:

Remove: Cylinder, Filter: High Pass

Filter Low Waven: 0.002 mm

### Checking of Metal Etching Residues Between Fine Lines

Using a scanning electron microscope (SEM) (SEMEDX type-N, manufactured by Hitachi, Ltd.), the areas between lines were observed to check the presence or absence of metal element peaks.

### Measurement of Adhesion Strength

As in Embodiment I, adhesion strength was measured according to IPC-TM-650-method.2.4.9 at a pattern width of 3 mm, a peel angle of 90 degrees, and a peel rate of 50 mm/min. Note that adhesion strength was measured under a constant temperature and humidity condition and after a pressure cooker test. Herein, the constant temperature and humidity condition is a state in which a sample to be measured is left to stand in a thermostatic chamber at 23° C. and at a humidity of 50% for 24 hours. The pressure cooker test was performed at 121° C. at a humidity of 100% for 96 hours.

### Example 155

The resin solution (f) was applied by a comma coater onto a surface of a PET film (trade name: Cerapeel HP, manufactured by Toyo Metallizing Co. Ltd.) having a thickness of 125 μm, and then multi-step drying was performed in a hot-air oven at 60° C./one minute, 80° C./one minute, 100° C./three minutes, 120° C./one minute, 140° C./one minute, and 150° C./three minutes to produce a thermoplastic polyimide single layer film provided with a PET film, the thermoplastic polyimide single layer film having a thickness of 25 μm. The glass transition temperature of the thermoplastic polyimide single layer film was 162° C. Subsequently, the PET film was separated, and after the thermoplastic polyimide single layer film was fixed on a pin frame, heating was performed stepwise at 180° C./60 minutes and 200° C./10 minutes. The surface of the thermoplastic polyimide single layer film was treated with a surface treatment agent (referred to as a “desmear solution”) including the permanganate used in Embodiment I, using a permanganate desmearing system manufactured by Atotech Corporation under the conditions shown in Table 10.

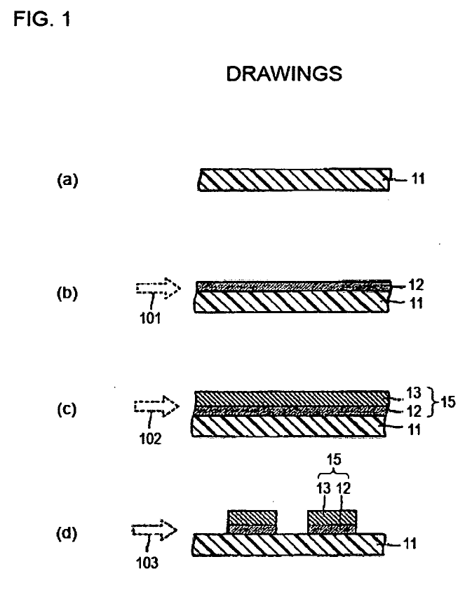

The surface roughness was measured before and after the desmearing treatment. The arithmetic average roughness Ra measured with a cutoff value of 0.002 mm was 0.008 μm each time. Using the thermoplastic polyimide single layer film subjected to the desmearing treatment as an insulating layer 11 as shown in FIG. 1(a), an electroless copper plating layer as an electroless plating layer 12 and an electrolytic copper plating layer as an electrolytic plating layer 13 were formed in that order as described in FIGS. 1(b) and 1(c) to form a copper layer having a thickness of about 18 μm as a wiring layer 15. As shown in FIG. 1(d), the wiring layer 15 was subjected to patterning for measuring adhesion strength with a pattern width of 3 mm. Then, the insulating layer 11 and the electroless plating layer 12 were subjected to heat treatment 103 in a hot-air oven at 180° C. for 30 minutes. The adhesion strength between the insulating layer 11 and the wiring layer 15 (i.e., adhesion strength between the insulating layer 11 and the electroless plating layer 12) was measured to be 10 N/cm under the constant temperature and humidity condition and 4 N/cm after pressure cooker test. The results thereof are shown in Table 19.

### Example 156

An insulating layer and a wiring layer were formed as in Example 155 except that the resin solution (g) was used, and adhesion strength of the wiring layer was measured. In this example, the glass transition temperature of the thermoplastic polyimide single layer film used as the insulating layer was 167° C. The surface roughness was measured before and after the desmearing treatment. The arithmetic average roughness Ra measured with a cutoff value of 0.002 mm was 0.009 μm each time. The adhesion strength between the insulating layer and the wiring layer was 11 N/cm under the constant temperature and humidity condition and 4 N/cm after pressure cooker test. The results thereof are shown in Table 19.

### Example 157

An insulating layer and a wiring layer were formed as in Example 155 except that the resin composition solution (h) was used, and adhesion strength of the wiring layer was measured. In this example, the glass transition temperature of the thermoplastic polyimide resin composition single layer film used as the insulating layer was 160° C. The surface roughness was measured before and after the desmearing treatment. The arithmetic average roughness Ra measured with a cutoff value of 0.002 mm was 0.007 μm for each time. The adhesion strength between the insulating layer and the wiring layer was 10 N/cm under the constant temperature and humidity condition and 4 N/cm after pressure cooker test. The results thereof are shown in Table 19.

### Example 158

An insulating layer and a wiring layer were formed as in Example 155 except that the laminated polyimide film (i) was used, and adhesion strength of the wiring layer was measured. The wiring layer was formed on the thermoplastic polyimide resin layer, i.e. a surface layer of the laminated polyimide film (i) serving as an insulating layer. The glass transition temperature of the laminated polyimide film (i) used as the insulating layer was 167° C. The surface roughness was measured before and after the desmearing treatment. The arithmetic average roughness Ra measured with a cutoff value of 0.002 mm was 0.008 μm for each time. The adhesion strength between the insulating layer and the wiring layer was 10 N/cm under the constant temperature and humidity condition and 4 N/cm after pressure cooker test. The results thereof are shown in Table 19.

### Example 159

An insulating layer and a wiring layer were formed as in Example 155 except that the laminated polyimide film (j) was used, and adhesion strength of the wiring layer was measured. The wiring layer was formed on the thermoplastic polyimide resin composition layer, i.e., a surface layer of the laminated polyimide film (j) serving as an insulating layer. The glass transition temperature of the laminated polyimide film (j) used as the insulating layer was 160° C. The surface roughness was measured before and after the desmearing treatment. The arithmetic average roughness Ra measured with a cutoff value of 0.002 mm was 0.008 μm for each time. The adhesion strength between the insulating layer and the wiring layer was 10 N/cm under the constant temperature and humidity condition and 4 N/cm after pressure cooker test. The results thereof are shown in Table 19.

TABLE 19

| | Example | Example | Example | Example | Example |
|---|---|---|---|---|---|
| | 154 | 155 | 156 | 157 | 158 |
| Material for | Solution | Solution | Solution | PI film (i) | PI film (j) |
| insulating | (f) | (g) | (h) | | |
| layer | | | | | |
| Structure of | Thermoplastic | Thermoplastic | Thermoplastic | Thermoplastic | Thermo- |
| insulating | PI | PI | PI | PI | Plastic PI |
| layer | | | | | composition/ |
| | | | | | Non-thermo- |
| | | | | | Plastic PI |
| Tg (° C.) of | 162 | 167 | 160 | 167 | 160 |
| insulating | | | | | |
| film | | | | | |
| Surface | 0.008 | 0.009 | 0.007 | 0.008 | 0.008 |
| roughness of | | | | | |
| insulating | | | | | |
| layer (μm) | | | | | |
| Heat | 180 × 30 | 180 × 30 | 180 × 30 | 180 × 30 | 180 × 30 |
| treatment | | | | | |
| conditions | | | | | |
| (° C. × min) | | | | | |
| Adhesion | 10 | 11 | 10 | 10 | 10 |
| strength | | | | | |
| Normal (N/cm) | | | | | |
| Adhesion | 4 | 4 | 4 | 4 | 4 |
| strength | | | | | |
| After PCT | | | | | |
| (N/cm) | | | | | |

### Example 160

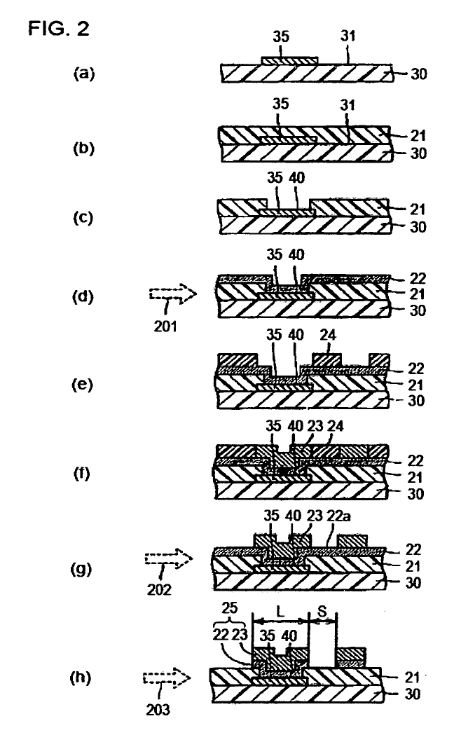

Using a copper-clad glass epoxy laminate including a copper foil (9 μm), an inner circuit board 30 as shown in FIG. 2(a) was formed. As shown in FIG. 2(b), using the laminated polyimide film (k) serving as an insulating layer 21, a semi-cured polyimide resin composition layer (adhesive layer) of the laminated polyimide film (k) was placed so as to face an inner circuit surface 31, and the laminated polyimide film (k) was laminated on an inner circuit board 30 by vacuum pressing under the conditions of a temperature of 130° C., a hot plate pressure of 3 MPa, a pressing time of 10 minutes, and a vacuum of 1 KPa. Subsequently, curing was performed by heating in a hot-air oven at 180° C. for 60 minutes, and thereby the insulating layer 21 was formed on the inner circuit board 30. During the vacuum pressing, a PET film was used as a bonding sheet. The glass transition temperature of the laminated polyimide film (k) used as the insulating layer was 160° C.

Subsequently, as shown in FIG. 2(c), using UV-YAG laser, a via hole 40 with an inner diameter of 30 μm was formed so as to pass through a region of the insulating layer 21 on the inner circuit layer 35. Subsequently, as shown in FIG. 2(d), an electroless copper plating layer serving as an electroless plating layer 22 was formed inside the via hole 40 and on the insulating layer 21, and then the insulating layer 21 and the electroless plating layer 22 were subjected to heat treatment 201 in a hot-air oven at 180° C. for 30 minutes. Subsequently, as shown in FIG. 2(e), a pattern of a plating resist film 24 was formed on the electroless plating layer 22. As shown in FIG. 2(f), an electrolytic copper plating layer serving as an electrolytic plating layer 23 was formed with a thickness of 10 μm. As shown in FIGS. 2(f) and 2(g), the plating resist film 24 was removed, and furthermore, as shown in FIGS. 2(g) and 2(h), exposed portions 22a of the electroless plating layer 22 were removed using a hydrochloric acid/ferric chloride-based etchant. Thereby, a printed circuit board including a wiring layer 25 with L/S=10 μm/10 μm was produced. The fine wiring with L/S=10 μm/10 μm had the value of line/space that was substantially as designed, and the wiring shape was satisfactory. Furthermore, the wiring layer was strongly bonded after pressure cooker test. Metal etching residues were not detected from the space sections. The results thereof are shown in Table 20.

### Example 161

A printed circuit board was produced as in Example 6 except that, as shown in FIG. 2(h), after the wiring layer 25 with L/S=10 μm/10 μm was formed, heat treatment 203 was performed at 180° C. for 30 minutes. The fine wiring with L/S=10 μm/10 μm had the value of line/space that was substantially as designed, and the wiring shape was satisfactory. Furthermore, the wiring layer was strongly bonded after pressure cooker test. Metal etching residues were not detected from the space sections. The results thereof are shown in Table 20.

### Comparative Example 10

Using a copper-clad glass epoxy laminate including a copper foil (9 μm), an inner circuit board 30 as shown in FIG. 2(a) was formed. As shown in FIG. 2(b), an epoxy resin sheet for a build-up substrate (50 μm) serving as an insulating layer 21 was laminated as shown in FIG. 2(b), and curing was performed at 170° C. for 30 minutes to form the insulating layer 21 on the inner circuit board 30. Subsequently, as shown in FIG. 2(c), using UV-YAG laser, a via hole 40 with an inner diameter of 30 μm was formed so as to pass through a region of the insulating layer 21 on the inner circuit layer 35, and desmear treatment was performed. The surface of the epoxy resin sheet was roughened by the desmear treatment to improve adhesion with an electroless plating layer. Subsequently, as shown in FIG. 2(d), an electroless copper plating layer serving as an electroless plating layer 22 was formed inside the via hole 40 and on the insulating layer 21. Then, as shown in FIG. 2(e), a pattern of plating resist film 24 was formed on the electroless plating layer 22. As shown in FIG. 2(f), an electrolytic copper plating layer serving as an electrolytic plating layer 23 was formed with a thickness of 10 μm. As shown in FIGS. 2(f) and 2(g), the plating resist film 24 was removed, and furthermore, as shown in FIGS. 2(g) and 2(h), exposed portions 22a of the electroless plating layer 22 were removed using a hydrochloric acid/ferric chloride-based etchant. Production of a printed circuit board including a wiring layer with L/S=10 μm/10 μm was attempted. However, in the surface of the insulating layer 21, the arithmetic average roughness Ra measured with a cutoff value of 0.002 mm was 0.2 μm, and the surface roughness of the insulator was high. Consequently, the line width was not stable, and it was not possible to form a satisfactory wiring pattern. Furthermore, copper was detected from the space sections. The results thereof are shown in Table 20.

As described above, in accordance with the present invention, it is possible to produce a printed circuit board in which an electroless plating layer which constitutes a fine wiring can be satisfactorily formed on the surface of an insulating layer having extremely low surface roughness, and the insulating layer and the fine wiring were strongly bonded to each other.

TABLE 20

| | Thermoplastic | Thermoplastic | |
|---|---|---|---|
| | PI | PI | |
| Structure of | composition/ | composition/ | |
| insulating | Non-thermoplastic | Non-thermoplastic | |
| layer | PI/ | PI/ | |
| Resin or | Thermoplastic | Thermoplastic | |
| Composition | PI composition | PI composition | Epoxy |
| Tg (° C.) of | 160 | 160 | — |
| insulating | | | |
| film | | | |
| Surface | 0.008 | 0.009 | 0.2 |
| roughness of | | | |
| insulating | | | |
| layer | | | |
| (μm) | | | |
| Heat treatment | 180 × 30 | 180 × 30 | (Curing of |
| conditions | | | epoxy resin) |
| (° C. × min) | | | 170 × 30 |
| Adhesion | Good | Good | Good |
| Normal | | | |
| Adhesion | Good | Good | Good |
| After PCT | | | |
| Wiring shape | Good | Good | Poor |
| Metal etching | Not detected | Not detected | Detected |
| residues from | | | |
| space sections | | | |

### INDUSTRIAL APPLICABILITY

As described above, according to the present invention, it is possible to form an electroless plating layer on an insulating layer with low surface roughness with strong adhesion strength. Therefore, the present invention can be widely used in manufacturing build-up circuit boards having fine wiring, (COF) substrates in which semiconductor devices are directly mounted on printed circuit boards, MCM substrates, and the like.

1. A polyimide resin composition comprising at least an organic thiol compound and a thermoplastic polyimide resin.

2. The polyimide resin composition according to claim 1, wherein the organic thiol compound is an organic dithiol compound and/or an organic trithiol compound.

3. The polyimide resin composition according to claim 2, wherein the organic dithiol compound and/or the organic trithiol compound is a triazine thiol derivative.

4. The polyimide resin composition according to any one of claims 1 to 3, wherein the thermoplastic polyimide is a polyimide resin obtained from a polyamic acid represented by general formula (1): 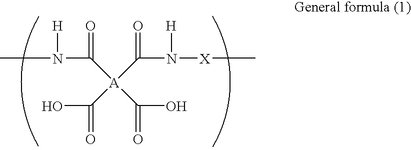
(wherein A represents a tetravalent organic group, and X represents a divalent organic group).

5. The polyimide resin composition according to claim 4, wherein A in general formula (1) is at least one tetravalent organic group selected from group (1):

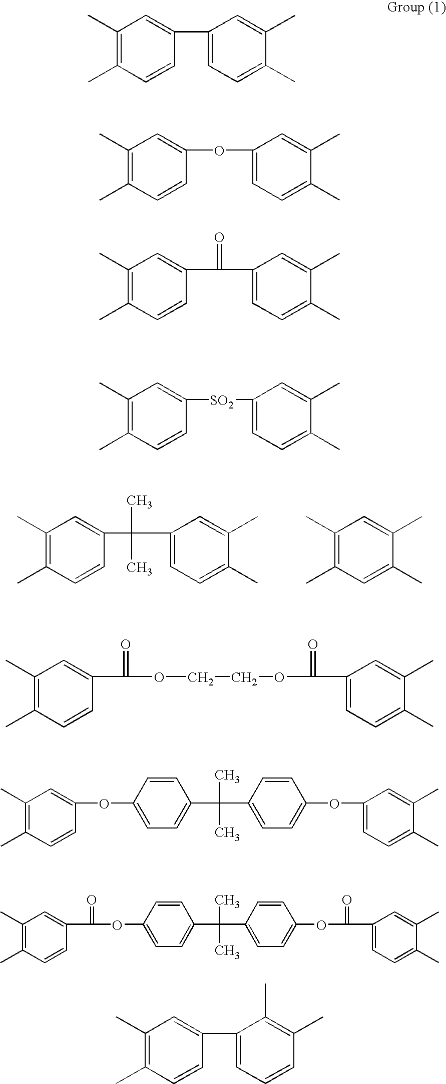

6. The polyimide resin composition according to claim 4, wherein X in general formula (1) is at least one divalent organic group selected from group (2):

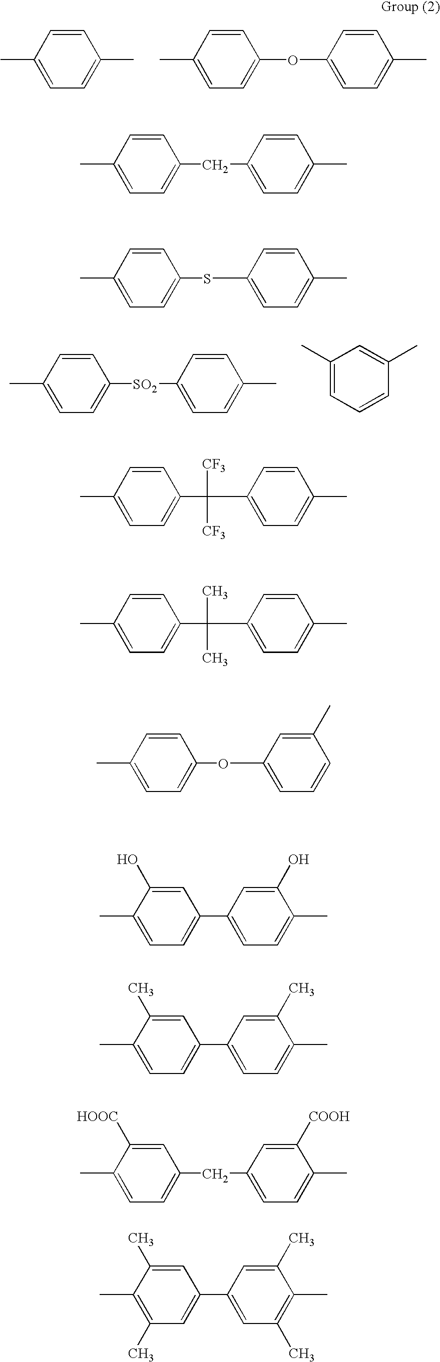

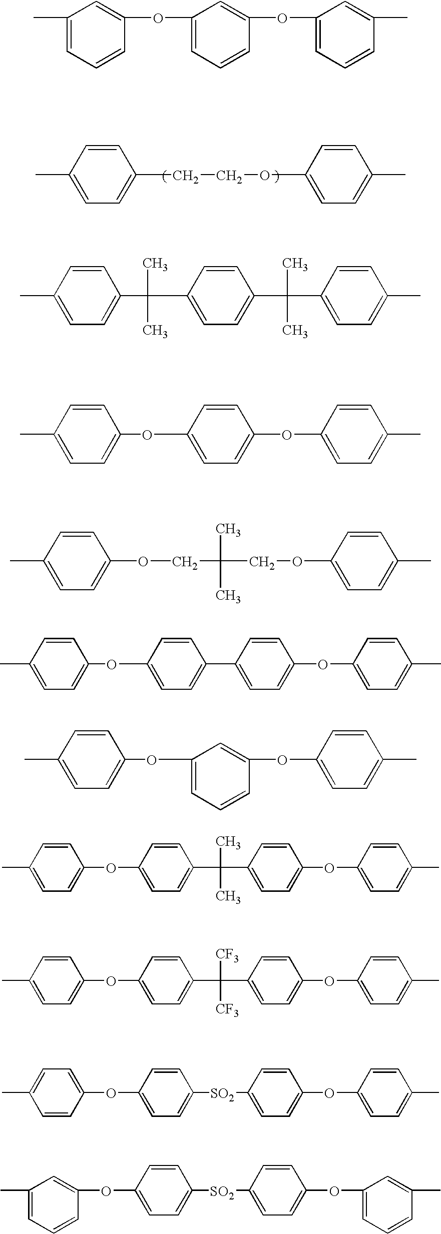

7. A polymeric film containing at least an organic thiol compound and a polyimide resin.

8. The polymeric film according to claim 7, wherein the organic thiol compound is an organic dithiol compound and/or an organic trithiol compound.

9. The polymeric film according to claim 8, wherein the organic dithiol compound and/or the organic trithiol compound is a triazine thiol derivative.

10. The polymeric film according to any one of claims 7 to 9, wherein the polymeric film containing the polyimide resin is a non-thermoplastic polyimide film.

11. The polymeric film according to any one of claims 7 to 9, wherein the polymeric film containing the polyimide resin is a single layer film containing a thermoplastic polyimide resin and the organic thiol compound.

12. The polymeric film according to any one of claims 7 to 9, wherein the polymeric film containing the polyimide resin is a film including a layer containing a thermoplastic polyimide resin disposed on one surface or both surfaces of a support composed of a resin selected from the group consisting of non-thermoplastic polyimide resins, polyamide-imide resins, polyetherimide resins, polyamide resins, aromatic polyester resins, polycarbonate resins, polyacetal resins, polysulfone resins, polyethersulfone resins, polyethylene terephthalate resins, phenylene ether resins, polyolefin resins, polyarylate resins, liquid crystal polymers, and epoxy resins.

13. The polymeric film according to claim 11, wherein the organic thiol compound is carried on the surface of the thermoplastic polyimide resin by dipping the thermoplastic polyimide resin in a solvent dissolving the organic thiol compound.

14. A polymeric film/metal foil laminate including a layer containing a thermoplastic polyimide resin on a surface thereof, wherein the polymeric film is the polymeric film according to claim 11.

15. The polymeric film/metal foil laminate according to claim 14, wherein the organic thiol compound is carried on the surface of the thermoplastic polyimide resin by dipping the thermoplastic polyimide resin in a solvent dissolving the organic thiol compound.

16. A polymeric film/adhesive layer laminate including a layer containing a thermoplastic polyimide resin on a surface thereof, wherein the polymeric film is the polymeric film according to claim 11.

17. The polymeric film/adhesive layer laminate according to claim 16, wherein the organic thiol compound is carried on the surface of the thermoplastic polyimide resin by dipping the thermoplastic polyimide resin in a solvent dissolving the organic thiol compound.

18. A laminate comprising the polymeric film according to any one of claims 7 to 9, and a metal film formed by electroless plating on at least one surface of the polymeric film.

19. A laminate comprising the polymeric film according to any one of claims 7 to 9, and a metal film formed by a physical method on at least one surface of the polymeric film.

20. A laminate comprising the laminate according to claim 14 and a metal film formed by electroless plating on the layer containing the thermoplastic polyimide resin of the laminate.

21. A laminate comprising the laminate according to claim 14 and a metal film formed by a physical method on the layer containing the thermoplastic polyimide resin of the laminate.

22. A printed circuit board comprising the polymeric film according to any one of claims 7 to 9.

23. A printed circuit board comprising the laminate according to claim 14.

24. A method for manufacturing a printed circuit board comprising a step of forming at least an electroless plating layer on an insulating layer which contains a thermoplastic resin and which has a surface roughness of less than 0.05 μm in terms of arithmetic average roughness Ra measured with a cutoff value of 0.002 mm.

25. A method for manufacturing a printed circuit board comprising a step of forming an insulating layer on an inner circuit surface having an inner circuit layer of an inner circuit board, the insulating layer containing at least a thermoplastic resin and having a surface roughness of less than 0.05 μm in terms of arithmetic average roughness Ra measured with a cutoff value of 0.002 mm, a step of forming a via hole that passes through a region of the insulating layer on the inner circuit layer, a step of forming an electroless plating layer inside the via hole and on the insulating layer, a step of forming a patterned electrolytic plating layer on the electroless plating layer, and a step of removing an exposed portion of the electroless plating layer.

26. The method for manufacturing the printed circuit board according to claim 24 or 25, further comprising a step of heat-treating at least the insulating layer and the electroless plating layer after the step of forming the electroless plating layer.

27. The method for manufacturing the printed circuit board according to claim 24 or 25, wherein the thermoplastic resin layer contains an organic thiol compound.

28. The method for manufacturing the printed circuit board according to claim 26, wherein, in the step of heat-treating the insulating layer and the electroless plating layer, the heating temperature is equal to or higher than the glass transition temperature of the insulating layer.

29. The method for manufacturing the printed circuit board according to claim 26, wherein, in the step of heat-treating the insulating layer and the electroless plating layer, the heating temperature is 300° C. or less.
